(19) United States
(12) Patent Application Publication
(10) Pub. No.: US 2006/0096918 A1
(43) Pub. Date: May 11, 2006

(54) Biofilm wastewater treatment devices

(76) Inventor: Michael J. Semmens, St. Paul, MN (US)

Correspondence Address: FISH & RICHARDSON P.C., PO BOX 1022, MINNEAPOLIS, MN, 55440-1022, US

(21) Appl. No.: 11/270,726

(22) Filed: Nov. 9, 2005

Related U.S. Application Data
(60) Provisional application No. 60/635,892, filed on Dec. 14, 2004.
(60) Provisional application No. 60/626,198, filed on Nov. 9, 2004.

(51) Int. Cl. C02F 3/00

(52) U.S. Cl. 210/615; 210/150

(57) ABSTRACT

Biofilters and methods for using them are described herein. The biofilters described include a network of hollow fiber membranes upon which a biofilm is caused to develop, filling the interstices between the membranes.

### CROSS-REFERENCE TO RELATED APPLICATIONS

This application claims priority from U.S. Provisional Application Ser. No. 60/626,198, filed Nov. 9, 2004, and from U.S. Provisional Application Ser. No. 60/635,892, filed Dec. 14, 2004, both of which are incorporated herein by reference in their entirety.

### TECHNICAL FIELD

This document relates to devices and methods for treating wastewater.

### BACKGROUND

When wastewater or contaminated ground water flows over a surface, bacteria and other microorganisms can attach and grow on the surface. These organisms, and materials secreted or otherwise produced by these organisms, can form a biologically active layer that may range in thickness from a few microns to millimeters in depth. Such biologically active layers typically are called biofilms.

Membranes (e.g., ultrafiltration or microfiltration membranes) can be used for filtration of wastewaters. Such membranes are especially designed to filter bacteria and other microorganisms out of wastewater and water supplies. When these membranes are used to filter solids out of the water, a biofilm can form on their filtering surfaces. The biofilm typically is undesirable since it blocks the pores of the membranes and slows filtration. In addition, the pressure required for filtration can increase, raising the cost of filtration significantly. A large cost associated with membrane filtration is the cost associated with providing conditions that keep the membrane surfaces as free as possible of biofilm and solids.

In other cases, supported biofilms (e.g., biofilms growing on the surface of a support such as a membrane) are purposely used to treat municipal or industrial wastewater or contaminated ground water. Such biofilms can remove organic compounds measured as chemical oxygen demand (COD), which predicts the oxygen requirement of the effluent and is used to monitor discharges and assess treatment plant performance, or biological oxygen demand (BOD), which refers to the amount of oxygen that would be consumed if all the organics in one liter of water were oxidized by bacteria and protozoa. Supported biofilms also can remove inorganic compounds such as ammonium, which can be oxidized to nitrate and then denitrified and reduced to nitrogen gas.

Biofilms grown on gas-permeable, aerated membranes also can be used to treat wastewater or contaminated ground water. Biofilm growth on such membranes can be advantageous, because high oxygen concentrations can be delivered directly to the active biofilms. In addition, the well-aerated conditions at the biofilm base can sustain higher microorganisms that require oxygen. Such higher organisms consume bacteria and can keep the biofilm quite porous. Further, their movements and activities can increase the effective “diffusion” of oxygen into the biofilm.

Biofilm growth on aerated membranes can, however, be a problem. In the presence of high substrate concentrations the biofilms may continue to grow, becoming thick and declining in performance. The biofilm performance becomes self-limiting and the advantage of membrane growth is lost. To be effective, the biofilms need to be used in conjunction with suspended growth so that the effective substrate concentrations are low. Alternatively, they need to be loaded at low rate so that the biofilms do not become overly thick. Biofilm thickness also can be controlled with high velocity shear or bubbles, but these can be energetically costly.

### SUMMARY

This document provides dynamic membrane-aerated biofilm filters (biofilters). The biofilters, designed such that the primary flow of wastewater is through the biofilm rather than along the surface of the biofilm, can be used for water (e.g., wastewater or contaminated ground water) treatment and water reuse. Due to the flow of wastewater through the biofilm, the biofilm in the filters provided herein typically receives contaminants by convection, which facilitates activity and effectiveness of the biofilm. The biofilm is supported by gas permeable membranes that can provide for aeration, enhancing cultivation of the biofilm. Because gas (e.g., air or oxygen) is supplied directly to the biofilm, these membrane supported biofilms have an advantage over biofilms growing on inert supports, which must obtain their oxygen from the air.

The present document is based on the discovery that biofilms can be successfully used to affect filtration of water. Closer examination of the problems with conventional membrane filtration revealed that the biofilm on the membrane surface actually can improve the effluent water quality. Thus, the biofilm itself is responsible for removing some of the particles and microorganisms from the water.

Described herein is a biofilter in which a biofilm is supported by gas permeable membranes. This device provides a means for creating a continuous active biofilm that is capable of filtration. The biofilm grows over the membrane, occluding the spaces in a membrane mesh/mat. The biofilm can retain or filter out solids from wastewater that is caused to flow through the biofilm. The biofilms in the devices provided herein typically contain about 20-100 g/L of dry biosolids, and the structure of the biofilms is tight enough to filter out many microorganisms, bacteria, and other particles from wastewater that would otherwise foul membranes. Thus, the biofilters provided herein can benefit the membrane performance and reduce energy costs as compared to membrane filtration.

Also described herein are methods that can encourage growth of biofilms on membrane meshes or mats. To operate at low energy (low velocities past the biofilm), the biofilters and systems provided herein must operate at low substrate loading rates, and the process is diffusion controlled. Thus, in the methods disclosed herein, the water is encouraged to flow through the biofilm very slowly. This allows for operation at low energy levels, although the approach facilitates delivery of substrate to the membrane biofilms. Biofilm conditions can be manipulated by altering the direction of flow, pulsing, altering the amount of time and the flow rate (loading rate) allowed to deliver new materials to the biofilm, and modulating the time for which the biofilm is not fed.

This document also provides methods for treating water (e.g., wastewater or contaminated ground water) using the biofilter devices described herein. These methods do not require the use of microporous membranes to achieve filtration. In addition, the methods require less space and energy than standard methods of water treatment, and have fewer problems associated with fine particulates and poorly settling sludges. These methods can be interfaced with aerobic and anaerobic processes.

In one aspect, this document features a biofilter having a network of hollow fibers and interstices bounded by the hollow fibers, wherein the hollow fibers have gas-permeable walls with exterior and interior surfaces, the interior surfaces defining lumens, wherein the lumens contain a fluid, and wherein a dynamic, continuous biofilm contacts the exterior surfaces and substantially occludes the interstices. The network can define a mesh, or can define one or more arrays of parallel or substantially parallel hollow fiber membranes. The network can be substantially planar. The interstices can be about 300 microns wide. The fluid can be a gas (e.g., oxygen, air, methane, hydrogen, or carbon dioxide). The biofilm can contain microorganisms that oxidize organic and/or inorganic compounds, or microorganisms that reduce organic and/or inorganic compounds. The network can have one or more inlets in fluid communication with the lumens and one or more outlets in fluid communication with the lumens.

In another aspect, this document features a biofilter system with two or more spaced-apart biofilters having a network of hollow fibers and interstices bounded by the hollow fibers, wherein the hollow fibers have gas-permeable walls with exterior and interior surfaces, the interior surfaces defining lumens, wherein the lumens contain a fluid, and wherein a dynamic, continuous biofilm contacts the exterior surfaces and substantially occludes the interstices.

In another aspect, this document features a method for treating water, the method comprising contacting a biofilter disclosed herein with flowing water under conditions in which the bulk flow of the water passes through the biofilm. The water can be wastewater or contaminated ground water.

In yet another aspect, this document features a method for treating water. The method can include contacting a biofilter disclosed herein with flowing water under conditions in which a portion of the water flows through the biofilm, while another portion of the water flows past the surface of the biofilm. The water can be wastewater or contaminated ground water.

This document also features a method for treating wastewater. The method can include contacting a biofilter system disclosed herein with flowing wastewater under conditions in which the bulk flow of the wastewater passes sequentially through the two or more spaced-apart biofilters.

In another aspect, this document features a method for cultivating a continuous biofilm filter. The method can include contacting a gas permeable membrane mesh with wastewater and allowing a biofilm to develop, and causing wastewater to flow through the membrane mesh and the biofilm by convective transport. The direction of wastewater flow can be reversible. The method can further include delivering a high oxygen flux through the gas permeable membrane mesh to the biofilm.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B are graphs plotting the fraction of biomass (FIG. 1A) and activity (FIG. 1B) of the indicated classes of microorganisms within a membrane-supported biofilm supplied with air.

FIGS. 2A and 2B are graphs plotting the fraction of biomass (FIG. 2A) and activity (FIG. 2B) of the indicated classes of microorganisms within a membrane-supported biofilm supplied with pure oxygen.

FIGS. 3A and 3B are diagrams depicting a biofilter as provided herein. FIG. 3A is a side view of the biofilter, showing a single membrane. FIG. 3B is an end view of the biofilter, showing cross-sections of three membranes and the stitches holding them together.

FIG. 4 is a diagram of the divisions of the biofilter domain used in the models discussed herein.

FIG. 5 is a diagram of the distribution of elements and grid nodes used in the one-dimensional biofilter model discussed herein.

FIG. 6 is a diagram of a biofilm element used to calculate mass balance. W, P, E, w, e, and dx represent parameters used to set up the grid and domains for the calculation.

FIG. 7 is a pair of graphs plotting oxygen concentration (upper panel) and substrate concentration (lower panel) profiles in the one-dimensional biofilter model discussed herein.

FIG. 8 is a diagram showing the region of oxygen diffusion around two membranes of a biofilter disclosed herein, as calculated using a one-dimensional model.

FIG. 9 is a diagram showing a domain representative piece of a biofilter used in the two-dimensional model discussed herein.

FIG. 10 is a diagram of the distribution of elements and grid nodes used in the two-dimensional biofilter model discussed herein. The dy and dx indicators represent parameters used to set up the grid and domains for the calculations.

FIG. 11 is a three-dimensional graph plotting oxygen concentrations in a two-dimensional model of a biofilter provided herein. Dark blue indicates no oxygen, while oxygen saturation is indicated by red-brown.

FIG. 12 is a plot plan view of the graph shown in FIG. 11.

FIG. 13 is a three-dimensional graph plotting substrate concentrations in a two-dimensional model of a biofilter provided herein.

FIG. 14 is a plot plan view of the graph shown in FIG. 13.

FIG. 15 is a pair of close-up contour plots showing oxygen concentrations (upper panel) and substrate concentrations (lower panel) as depicted in FIGS. 12 and 14, respectively.

FIG. 16 is a three-dimensional graph plotting activity of microorganisms in a two-dimensional model of a biofilter provided herein.

FIG. 17 is a plot plan view of the graph shown in FIG. 16.

FIGS. 18A and 18B are graphs showing activity around a pair of membranes at an oxygen concentration of 9 mg/L (FIG. 18A) and 18 mg/L (FIG. 18B).

FIG. 19 is a three-dimensional graph plotting the effect of oxygen concentration (z axis) and membrane spacing (x axis) on substrate removal (y axis).

FIG. 20 is a two-dimensional representation of the graph shown in FIG. 19.

FIG. 21 is a diagram of a potted membrane module.

FIG. 22 is a diagram of a frame for a membrane module.

FIG. 23 is a diagram of a cross-section (left) and a side view of an assembled membrane module.

FIG. 24 is a diagram of a hollow fiber membrane bioreactor that can be used under aerobic conditions.

FIG. 25 is a diagram of a hollow fiber membrane bioreactor that can be used under anoxic conditions.

### DETAILED DESCRIPTION

This document provides dynamic membrane-aerated biofilters. As used herein, the term “biofilter” refers to a network (e.g., a mesh) of fibers (e.g., hollow, gas permeable membrane fibers), the surfaces of which are substantially covered with a dynamic biofilm, wherein the biofilm substantially occludes the interstices between the individual fibers. The biofilters provided herein can be used for wastewater treatment and water reuse. In the methods for water treatment that are provided herein, at least some of the wastewater is encouraged to flow through the biofilm rather than along the surface of the biofilm. Thus, the biofilm in the filters provided herein typically receives contaminants by convection, facilitating activity and effectiveness of the biofilm. The gas permeable membrane can provide aeration at the base of the biofilm, and also can provide nutrients that can enhance cultivation of the biofilm.

1. Biofilms

Most microorganisms live and grow in aggregated forms such as biofilms, flocs (‘planktonic biofilms’), and sludges (Costerton et al. (1995) Annu. Rev. Microbiol. 49:711-745; and Wimpenny (2000) In Community Structure and Co-operation in Biofilms (ed. Allison, Gilbert, Lappin-Scott, and Wilson), pp. 1-24, Cambridge University Press, Cambridge, UK). Biofilms and flocs are accumulations of multivalent cations, inorganic particles, and biogenic material (detritus), as well as colloidal and dissolved compounds. These forms of growth frequently are lumped together under the term “biofilm.” Biofilms are ubiquitously distributed in aquatic environments, on tissues of plants and animals, and on surfaces of technical systems such as filters and other porous materials, reservoirs, pipelines, ship hulls, heat exchangers, separation membranes, and sometimes on medical devices. Biofilms typically develop at phase boundaries, and can frequently be found adherent to a solid surface at solid-water interfaces. Biofilms also can be found at solid-air interfaces.

Biofilms can be used to eliminate nutrients (e.g., organic and inorganic compounds) and/or xenobiotics from wastewater. For a biofilm to be successful for elimination of particular nutrients or xenobiotics, microorganisms with the required metabolic capacity must populate and be maintained in the biofilm. Biofilms can contain any species of microorganism. For example, a biofilm can contain bacteria from the α-, β-, or γ subclass of Proteobacteris, Gram-positive bacteria with a high GC content, and/or bacteria from the Cytophaga-Flavobacterium group. Even slow-growing nitrifiers and xenobiotic-degrading bacteria can propagate and persist in biofilms. These include, for example, chemolithoautotrophic ammonia-oxidizers (e.g., Nitrosomonas sp., Nitrosococcus, Nitrosospira, Nitrosovibrio, and Nitrosolobus) and nitrite-oxidizers (e.g., Nitrobacter sp.) involved in microbial nitrification of ammonium to nitrate. By providing sufficient amounts of oxygen to a biofilm via a hollow fiber membrane, for example, a high concentration of nitrifiers can be achieved irrespective of their low growth rate, and independent of hydraulic loading.

Biofilm microorganisms in the biofilters provided herein may use membrane delivered gas as an electron acceptor, an electron donor, or as a required nutrient for growth. The biofilm may be comprised of a single bacterial species (pure culture) or it may comprise a consortium of bacteria that naturally develop when exposed to the environmental conditions that are created in the biofilm. Typically, bacteria within a biofilm are those that thrive on the local conditions (e.g., pH, water quality, character and type of electron acceptors and donors, and availability of nutrients such as nitrogen, phosphorous, and carbon dioxide).

In addition to bacteria, biofilms can contain protozoan and metazoan organisms such as invertebrates (e.g., nematodes), flagellates, and ciliates (e.g., rotifers) that are commonly found in the biology of wastewater and that can thrive within a biofilm if conditions permit. These organisms can include, without limitation, members of the genera Nais, Podophrya, Prodiscophrya, Acineria, Carchesium, Vorticella, Epistylis, Opercularia, Aspidisca, Metopus, Trimyema, and Dexiotricha. For example, a biofilm that develops under conditions that include low substrate concentrations may contain relatively high numbers of filamentous organisms (e.g., fungi). Alternatively, a biofilm exposed to high substrate concentrations and plentiful nutrients typically will exhibit exponential bacterial growth. Although the biomass of protozoa and metazoa in biofilms typically is low as compared to the biomass of bacteria, protozoans and metazoans can significantly affect the stability of the ecosystem of a biofilm. Protozoan and metazoan organisms can influence the performance of biofilms by preying on the bacteria within the biofilm, and may affect the numbers of bacteria, or specific populations of bacteria, that are involved in the transformation of wastewater compounds. Protozoans also may affect the “porosity” of the biofilm and the permeability of the biofilm to water. For example, high protozoan and metazoan populations may create openings and preferred paths for water flow through a biofilm, increasing the apparent permeability of the biofilm.

The composition of microbial communities in biofilms can be investigated in different ways. It is possible to characterize microorganisms subsequent to their cultivation, or qualitative analysis can be performed without cultivation, using molecular techniques. For example, microorganism DNA fragments can be amplified using PCR and separated using gel electrophoresis (e.g., denaturing gradient gel electrophoresis or temperature gradient gel electrophoresis), resulting in distinguishable fingerprints. Particular members of a microbial community or particular physiological properties can be detected by hybridizing to probes for specific genes.

To enumerate particular bacterial populations and to localize specific bacteria in a biofilm, in situ methods including immunofluorescence techniques or hybridization with fluorescently labeled oligonucleotides can be used. Such methods typically are less time-consuming than standard bacteriological methods, and a selection of particular microbial species by the composition of the culture medium or cultivation conditions is avoided. Immunological techniques, however, can be complicated by the presence of extracellular polymeric substances (EPS, see below), since the diffusion of antibodies into the biofilm and contact between the antibody and the target cells may be impeded. Thus, fluorescent in situ hybridization (FISH) with oligonucleotide probes may be a preferred method for evaluating the taxonomic structure of a biofilm. In addition, rRNA-targeted oligonucleotide probes may be particularly useful, given the usefulness of 16S and 23S rRNA molecules as phylogenetic markers. In addition, examination of biofilms with genus or species-specific probes can provide detailed information about the composition of microbial communities with regard to functional aspects. For example, different probes for detection of ammonia- and nitrite-oxidizing bacteria can be used to characterize nitrifying microbial communities in wastewater. Examples of probes that can be used to evaluate biofilm composition include those listed in Biofilms in Wastewater Treatment—An Interdisciplinary Approach (ed. Wuertz, Bishop, and Wilderer), 2003, pp. 236-237, IWA Publishing, London.

To evaluate the microorganism population of a biofilm, the biofilm can be removed from its support surface using a technique such as sonication, for example, which also can homogenize the sample and diminish the number of aggregates. Samples can be taken at different times and from different depths of a biofilm, allowing detection of temporal and spatial gradients in the taxonomic composition of the biofilm.

The microorganisms within biofilms exist in close association at high cell density, and are embedded in a matrix of EPS. EPS production is a general microbial property that seems to be expressed in most environments. The ability to form EPS is widespread among prokaryotic organisms, but also can occur in eukaryotic microorganisms such as microalgae (e.g., diatoms; Cooksey (1992) In Biofilms—Science and Technology (ed. Melo, Bott, Fletcher, and Capdeville), pp. 137-147, Kluwer Academic Publishers, Dordrecht, UK; and Khandeparker and Bhosle (2001) Biofouling 17:117-127) and fungi (e.g., yeasts and molds; McCourtie and Douglas 1985, and Sutherland 1996). EPS are not essential structures of bacteria, but under natural conditions EPS production seems to be an important feature of survival since most environmental bacteria occur in aggregates such as flocs and biofilms whose structural and functional integrity are based essentially on the presence of an EPS matrix.

Thus, EPS are considered as the key components that determine the morphology, architecture, coherence, physicochemical properties, and biochemical activity of microbial aggregates. EPS form a three-dimensional, gel-like, highly hydrated and locally charged biofilm matrix in which the microorganisms essentially are immobilized. In general, the proportion of EPS in biofilms can vary between about 50% and about 90% of the total organic matter (Christensen and Characklis (1990); and Nielsen et al. (1997) Wat. Sci. Tech. 36:11-19). In activated sludge and sewer biofilms, 85-90% and 70-98%, respectively, of total organic carbon were found to be extracellular, indicating that cell biomass may constitute only a minor fraction of the organic matter of microbial aggregates in wastewater environments (Froland et al. (1996) Wat. Res. 30:1749-1758; and Jahn and Neilsen (1998) Wat. Sci. Tech. 37:17-24). EPS are involved in the formation of activated sludge flocs (bioflocculation) and the development of fixed biofilms (e.g., in trickling filters, rotating biological contactors, fluidized bed reactors, or submerged fixed-bed reactors) (Bryers and Characklis (1990) In Biofilms (ed. Characklis and Marshall), pp. 671-696, John Wiley and Sons, New York; and Bitton (1994) Wastewater Microbiology Wiley-Liss, Inc., New York).

EPS can include substances such as, for example, polysaccharides (e.g., monosaccharides, uronic acids, and amino sugars linked by glycosidic bonds), polypeptides, nucleic acids, lipids/phospholipids (e.g., fatty acids, glycerol phosphate, ethanolamine, serine, and choline), and humic substances (e.g., phenolic compounds, simple sugars, and amino acids). EPS composition can be evaluated after removing these macromolecules from the microbial cells. Physical and chemical methods, including centrifugation, filtration, heating, blending, sonication, and treatment with sodium hydroxide, complexing agents, and ion-exchange resins, can be used to extract EPS from microbial aggregates (Jahn and Nielsen (1995) Wat. Sci. Tech. 32:157-164; and Nielsen and Jahn (1999) In Microbial Extracellular Polymeric Substances (ed. Wingender, Neu, and Flemming), pp. 49-72, Springer, Berlin). Use of a cation-exchange resin combined with stirring, for example, can be used to isolate EPS from a biofilm without causing significant cell lysis. Such methods are based on removal of calcium ions, destabilizing EPS structure and facilitating separation of EPS from cells.

2. Biofilters and Biofilter Systems

Conventional biofilms: Biofilms grown on solid surfaces (“conventional biofilms”) can be used in wastewater treatment processes such as trickling filters and rotating biological contactors. In these processes, wastewater moves parallel to the surface of the biofilm, and the transfer of contaminants from the wastewater to the biofilm occurs largely as a result of diffusion. The substrates, including COD, dissolved oxygen (DO), and nitrogen (N), must diffuse from the bulk wastewater across a stagnant liquid boundary layer to the surface layer of the biofilm. At low substrate concentrations it is possible that some contaminants and DO are provided to the biofilm by convective flow. However, substrate concentrations generally are high in wastewater treatment applications, so convective transport typically is not thought to be significant.

Since conventional biofilms rely on diffusion from the wastewater for the supply of substrates, they tend to grow most rapidly at the biofilm-wastewater interface where substrate concentrations are highest. Concentrations of DO, COD, and N fall as these compounds diffuse into an active biofilm as a result of biological activity. The character of the biofilm is determined according to which substrates remain available at depth. The oxidation-reduction potential, the active microbial processes, and the microbiology of the biofilm tend to vary with biofilm depth and the operating conditions in the bioreactor. It is clear, however, that the microorganisms within the biofilm generally are substrate limited and therefore remove wastewater contaminants at a fraction of their potential ability. In aerobic processes, biofilms typically are oxygen limited at depth.

Membrane filtration: Membrane bioreactors (MBRs) also can be used to provide solids separation in, for example, municipal activated sludge plants that have historically used sedimentation tanks for this purpose. Membranes provide a higher quality effluent, remove pathogens including virus particles, and are less prone to upset than sedimentation tanks. In addition, since membranes hold back all of the planktonic bacteria and microorganisms, the treatment performance of the MBR typically is better than conventional systems.

Membranes can be installed directly in the aeration tanks of municipal wastewater treatment plants. Large areas of membrane typically are submerged in the bioreactor and a trans-membrane pressure of about 2-10 psi is provided to cause the treated wastewater to flow through the membrane. The filtrate becomes the plant effluent and all the retained solids remain in the aeration tank. Microfiltration membranes with a pore size of about 0.4 μm or less typically are used for filtration. These small pores can become plugged with biofilm. Unlike membrane-aerated biofilm (MAB), such biofilm is not supplied with nutrients or oxygen from the membrane. Further, development of this biofilm within the pores can hamper the filtration process and typically is considered undesirable.

When water is filtered through an MBR membrane, solids tend to accumulate at the surface of the membrane and contribute to additional headloss. Membranes generally must be operated at relatively low filtration rates to avoid problems with membrane fouling and adverse headloss development. Most MBRs operate at about 10-30 liters/m²/h (Lmh). This translates to an approach velocity of about 1-3 cm/h.

To avoid accumulation of solids at the membrane surface, the membranes are operated in cross-flow. High water velocities and/or large bubbles are used to create shear at the membrane surface so as to lift solids away from the membrane and minimize fouling. This approach also helps to maintain an acceptable headloss and a constant filtration rate across the membrane. Unfortunately, the need to provide shear in the bioreactor imposes a significant energy penalty on the process and adds to the cost of treatment.

Although aeration is beneficial, the large bubbles needed to keep the membranes clean are not as efficient in transferring oxygen as conventional fine bubble diffusers. In addition, the high shear conditions required to keep the membranes clean also affect the microorganisms and break down the floc structure. As a result, there are greater concentrations of colloidal particles, planktonic bacteria, and small particles in MBRs than typically are found in conventional activated sludge plants. Operators have found that these changes in the floc structure of the biosolids cause problems with sludge settling and sludge dewatering. Most MBR facilities have had at least some problems with residuals handling and disposal. In addition, the colloidal solids have been implicated in membrane fouling. These fine solids can block the pores of the membrane and reduce membrane fluxes with time.

Membrane-aerated biofilms: MABs are similar, in some respects, to biofilms grown on solid supports. Unlike conventional biofilms, however, that gas permeable membranes are used to support the biofilm. MABs can be aerated through the membrane, and thus the biofilm can receive oxygen from the base of the biofilm. This leads to a very different biofilm environment as compared to conventional biofilms. In MABs, the oxygen diffuses in the opposite direction from the COD and N. If wastewater is aerated, the dissolved oxygen may enter the biofilm from both the wastewater and the membrane. The availability of DO deep within the biofilm can encourage the growth of nitrifying organisms, and can provide an oxygen-rich environment that supports the growth of higher organisms such as protozoans, rotifers, and nematodes.

Biofilm growth is limited by the delivery rate of substrates. Typically, the delivery rate is limited by liquid film diffusion of ammonium, oxygen, and the compounds contributing to COD. Growth in biofilms also is controlled by local DO concentrations. MABs have an advantage over conventional biofilms in that they can provide oxygen to the base of the biofilm to avoid this problem. In both conventional biofilms and MABs, most microorganisms operate at a small fraction of their ability. Typically, overall activity levels are less than 5% of their maximum utilization efficiency.

The rate of wastewater purification typically is a function of biofilm thickness. Good removal performance is obtained when the fluxes of substrates and oxygen into the biofilm are large. However, the flux of substrates into the biofilm is strongly dependent upon biofilm thickness. When the biofilm is thin, it is biomass limited and there is a rapid increase in flux with increasing biofilm thickness. On the other hand, when the biofilm is thick, the increasing diffusive resistance of the outer inactive layers slows the flux of substrates to the active region of the biofilm. As a result, there is an optimum thickness that corresponds to rapid removal kinetics and good performance. This thickness is dependent upon the wastewater composition. For example, Shanahan and Semmens (Envir. Sci. Tech. (2004) 38:3176-3183) showed that the greatest fluxes of ammonia-N, nitrate-N, COD, and oxygen into and within a biofilm typically occur within the first week of operation, and correspond to a biofilm thickness of 200-400 microns. MABs can grow to become quite thick, however. For example, biofilms as thick as 2 mm have been grown on flat sheet membranes in contact with municipal sewage. With oxygen and other substrates diffusing from opposing directions, a thick biofilm is detrimental. The oxygen and other substrates must diffuse through thick layers of biofilm to supply aerobic heterotrophic bacteria that require both for growth. This means that aerobic heterotrophs grow most productively within the biofilm rather than at the surface, as is found for solid supported biofilms.

Given the above, it is clearly important to control biofilm thickness in order to gain the maximum advantage from MABs. A biofilm is a living community of microorganisms, and its behavior is adaptive. For example, if high shear conditions are imposed to control biofilm thickness, the microorganism community structure may change and the cells may secrete more extracellular polysaccharides to better anchor themselves to the surface. Conventional methods of shearing biofilms (e.g., gas sparging and high velocity flow) thus are difficult to use in order to reliably and consistently maintain biofilms of specific thicknesses.

Dynamically formed biofilters: Biofilms created on aerated or gas permeable membranes can benefit from a design that encourages water flow through the biofilm by convection. In particular, the convective transport of substrate increases the delivery of substrate to the microorganisms in the biofilm, and thus provides more effective water treatment. In addition, the biofilm structure itself serves as a filter, and can remove colloidal particles, flocs, and suspended particulates when the wastewater is caused to flow through the biofilm.

Thus, the biofilters provided herein are designed to increase the flux of substrates to the biofilms by causing water to flow through the biofilms rather than (or in addition to) across the surface of the biofilms. By encouraging convection, substrate transport to the biofilm is enhanced. Wastewater containing COD and ammonium can be encouraged to flow slowly through biofilms growing on a network of hollow fiber membranes that are spaced apart. These membranes may be supplied with air, for example, to encourage oxygen transfer and create aerobic conditions.

The gas permeable membranes used in the devices disclosed herein are non-wetting under the conditions of operation. Dense membranes such as polydimethyl siloxanes and polymethyl pentenes can be used. Alternatively, microporous membranes can be coated such that they are non-wetting. For example, a compound such as polydimethyl siloxane or silicone can be used to coat microporous membranes such as polyolefin, such that they are water-impermeable and non-porous while remaining gas permeable. In addition, any other suitable technique can be used to render the membranes water-impermeable and non-porous.

The hollow fiber membranes useful in the biofilters provided herein typically are woven or stitched together to create a fabric (e.g., a mat, mesh, weave, or series of stitched parallel fibers). In some embodiments, for example, the hollow membrane fibers are arranged parallel to one another, and are stitched together or otherwise attached to one another such that they are spaced apart from one another. In other embodiments, however, the membranes can be arranged to form a mesh screen-like structure, for example. The membranes can form a flexible network that can be arranged in a substantially planar or non-planar configuration. Membranes useful in the biofilters provided herein can be obtained commercially from suppliers such as Membrana (Charlotte, N.C.), which sells membranes such as the Celgard® X30-240 Microporous Hollow Fiber Membrane Array.

The gas-permeable walls of the hollow fiber membranes can have exterior surfaces and interior surfaces, with the interior surfaces defining lumens that can contain a fluid (e.g., a liquid or a gas). The membranes can have an outer diameter between about 50 microns and about 2000 microns (e.g., 50, 100, 150, 200, 250, 260, 270, 280, 290, 300, 310, 320, 330, 340, 350, 400, 450, 500, 550, 600, 700, 800, 900, 1000, 1100, 1200, 1300, 1400, 1500, 1600, 1700, 1800, 1900, or 2000 microns), an inner diameter between about 30 and about 1500 microns (e.g., 30, 50, 70, 100, 120, 140, 160, 180, 200, 210, 220, 230, 240, 250, 260, 270, 280, 290, 300, 350, 400, 450, 500, 550, 600, 700, 800, 900, 1000, 1100, 1200, 1300, 1400, or 1500 microns), and a wall thickness between about 10 and about 250 microns (e.g., 10, 11, 12, 13, 14, 15, 16, 17, 18, 19, 20, 21, 22, 23, 24, 25, 26, 27, 28, 29, 30, 40, 50, 60, 70, 80, 90, 100, 125, 150, 175, 200, 225, or 250 microns).

The spacing of the hollow fiber membranes provides openings (interstices) between the membranes that can be between about 100 microns and about 500 microns wide (e.g., 100, 120, 140, 150, 160, 180, 200, 210, 220, 230, 240, 250, 260, 270, 280, 290, 300, 310, 320, 330, 340, 350, 360, 370, 380, 390, 400, 420, 440, 450, 460, 480, or 500 microns wide). For biofilters that contain parallel membranes, width is measured perpendicular to the direction of the membranes. For biofilters in which the membranes define a mesh with square interstices, width is measured as the distance between opposing sides of the opening. For biofilters in which the membranes define a mesh with rectangular interstices, width is measured as the longer of the distances between opposing sides. For biofilters in which the membranes define a mesh with irregular interstices, width is measured as the longest distance across the openings. In the biofilters disclosed herein the interstices are substantially occluded by a biofilm. That is, the widths of the interstices are at least about 80% (e.g., about 80%, 82%, 85%, 87%, 90%, 92%, 95%, 98%, 99%, or 100%) filled with a biofilm.

Given that the hollow fiber membranes can be between about 50 and about 2000 microns in diameter, the hollow fiber membranes can have a porosity between about 5% and about 91% (e.g., 5%, 10%, 15%, 20%, 25%, 30%, 33%, 35%, 40%, 42%, 44%, 45%, 46%, 47%, 48%, 49%, 50%, 51%, 52%, 53%, 54%, 55%, 56%, 58%, 60%, 65%, 70%, 75%, 80%, 85%, 90%, or 91%). For example, if a membrane fabric has membranes with an outer diameter of 300 microns and a width of the space between the membranes of 200 microns, the porosity of the membrane fabric is 40% ([200/(200+300)]*100%).

The membranes used in the biofilters provided herein can be, for example, parallel or substantially parallel arrays of stitched-together hollow fibers that define one or more flexible sheets. The sheets can define any shape. When viewed from above or below, for example, a biofilter can define a circle, a square, a rectangle, an oval, or any other shape. In some embodiments, the stitched-together hollow fiber membranes in a biofilter can be gathered together (i.e., “potted”) at each end, such that the sheet of membranes defines a rounded shape that is elongated or pointed at opposing sides. Such potting can be useful to operably connect the hollow fiber membranes to inlet and outlet ports in fluid communication with the interior lumens for supply and removal of a fluid (e.g., a gas such as air, oxygen, methane, hydrogen, or carbon dioxide). In these embodiments, the hollow fiber membranes can be considered to be “substantially parallel” to one another, particularly in central regions of the biofilter.

A biofilter also can have any dimensions. Typically, a sheet of stitched-together hollow fiber membranes in a biofilter can between about 0.5 meters and about 5 meters (e.g., 0.5, 0.75, 1, 1.5, 2, 2.5, 3, 3.5, 4, 4.5, or 5 meters) in width or diameter. In addition, a biofilter can have any thickness. As disclosed above, and in some embodiments, the membranes can be between about 50 and about 2000 microns in thickness (e.g., between about 200 microns and about 600 microns in thickness, or about 400 microns in thickness). The biofilms growing thereon can have any thickness, but typically may be between about 400 microns and about 1 mm in thickness (e.g., 400, 500, 600, 700, 800, 900, or 1000 microns). Thus, in some embodiments a biofilter can have a total thickness between about 450 and about 3000 microns (e.g., 450, 500, 550, 600, 650, 700, 750, 800, 850, 900, 950, 1000, 1050, 1100, 1150, 1200, 1250, 1300, 1400, 1500, 1600, 1700, 1800, 1900, 2000, 2200, 2400, 2600, 2800, or 3000 microns).

Biofilters can be arranged into systems in which two or more (e.g., 2, 3, 4, 5, or 6) sheets or networks of hollow fiber membranes are spaced apart such that wastewater passing through a first biofilter then contacts and passes through a second biofilter and, in some embodiments, subsequent biofilters. In such systems, the bulk flow of wastewater thus passes sequentially through each individual biofilter. As described below, a particular type of fluid (e.g., gas) can be passed through the membranes of a biofilter in order to encourage particular reactions. A biofilter system can take advantage of this aspect by having a different type of fluid present in each of the separate biofilter layers, such that multiple reactions can be encouraged and a plurality of nutrients and xenobiotics can be eliminated from the wastewater.

The exterior surfaces of the hollow fiber membranes can be contacted by a biofilm, and the interstitial openings between the hollow fiber membranes can be filled in by the biofilm to create a living filter through which wastewater can flow. A biofilm can be caused to naturally develop on a biofilter membrane simply by exposing the membrane to wastewater, such that the biofilm that develops contains microorganisms that thrive in the particular wastewater environment. Alternatively, a biofilter membrane can be exposed to a “starter culture” containing a particular population of microorganisms before it is exposed to wastewater. This technique can be useful if elimination of a particular compound is desired, or if a biofilm that can carry out a particular biochemical reaction is desired.

3. Methods for Using the Devices Provided Herein

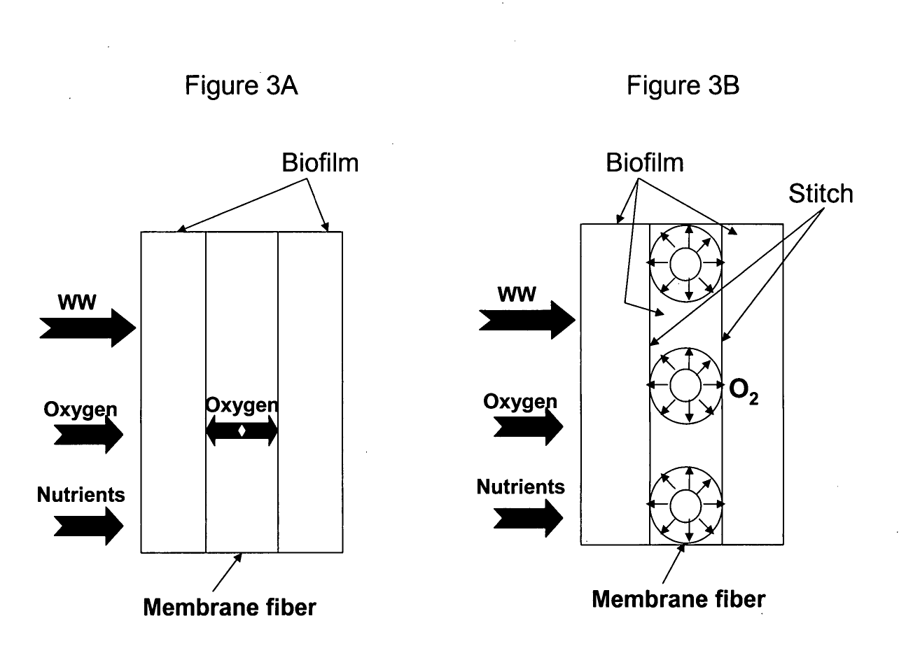

The devices provided herein rely on the biofilm itself to provide filtration. This concept is illustrated in FIGS. 3A and 3B. Thin layers of microorganisms and particulates can form on the surfaces of membrane fabrics. This accumulation of microorganisms and particulates actually can improve the effluent quality and enable the biofilter to remove particles that are significantly smaller than the pore size of the clean membrane fabric. The present disclosure recognizes this effect of the microbiology, and capitalizes on the formation of biofilm to take advantage of it.

The provision of air is not essential to the present approach. It is possible that instead of membranes, a screening material of solid or non-hollow fibers with geometry similar to that described above could be used. Such an approach would rely on the growth of anaerobic bacteria to fill the openings in the membrane fabric and provide an anaerobic biofilter. However, the ability to provide oxygen to wastewater flowing through a biofilm facilitates aerobic processes that, generally, are beneficial.

First, when air is supplied to the base of a biofilm, it encourages aerobic growth that is more rapid than anaerobic growth. The growth within a biofilm therefore is likely to be greatest close to and between the hollow fiber membranes where the DO is high. Further away from the membrane surface, the DO will be depleted, denitrification and anaerobic processes will prevail, and growth will be somewhat slower. Thus, the biofilm of a membrane-aerated biofilter will tend to grow out from the outer surfaces of the hollow fiber membranes.

Second, just as shear is used in conventional MBRs, shear can be used to keep the biofilm disclosed herein from growing too thick. This shear may be provided by intermittent mixing or aeration, and will cause the surface biofilm to detach. The surface biofilm is, of course, the region of the biofilm that removes the bulk of the particulates from the wastewater, and it is therefore the region of the biofilm that imposes the greatest resistance to flow. Thus, its detachment can have a beneficial impact on the pressure drop across the biofilm. The fact that the biofilm surface is being pushed out by the underlying growth can promote surface sloughing and facilitate low headloss filtration.

Regions of the biofilm that are close to and between the membranes (e.g., within the interstices) typically are rich in DO, and can provide an attractive environment for protozoans, rotifers, and higher microorganisms. These higher organisms, which have been observed in previous studies of MABs, effectively feed upon bacteria, particulates, and colloids, and can assist in keeping the biofilm porous and permeable to water flow.

The slow flow of wastewater through the biofilm can dramatically improve the substrate removal kinetics within the biofilm. The potential is illustrated in the following hypothetical calculation. A membrane fabric having an area of 1 m² is installed in a reactor, and this fabric is comprised of membranes that are 400 microns in external diameter and spaced 400 microns apart such that it has a 50% porosity. A biofilm of 1 mm grows over the entire membrane support, providing a 2.2 L volume of biomass. The biomass density is about 40 g/L (about 10 times the biomass concentration in a conventional mixed activated sludge plant). If the membrane is subjected to a flow of 20 Lmh, then this biofilm would provide a contact time of 0.11 hours, or about 7 minutes. This contact time, though short, may provide a significant level of treatment when the biomass concentration is so high and there is available DO.

The biofilters provided herein can be operated in a manner similar to a conventional membrane filter operated in crossflow. Surface shear flow may be necessary to assist with particle and biofilm detachment to maintain a desirable flux and an acceptable pressure drop. The pressure-flux relationship of the biofilm filter can be identified as a function of operating conditions (e.g., water quality, biofilm thickness, oxygen concentration, and solids concentrations in the wastewater).

Water can be forced through a biofilter by applying positive pressure on the influent, applying negative pressure (e.g., a vacuum) on the effluent, or a combination of the two methods. When a biofilter system is used in which two or more networks of hollow fiber membranes are spaced apart for sequential filtration of wastewater, positive and/or negative pressure may be applied between the networks as well as on the outermost networks. In some embodiments, the pressure can be pulsed rather than continuous, allowing for intermittent or even reverse flow of the wastewater, and permitting organism growth during stationary times. Water can be applied to the biofilters provided herein such that the bulk flow of the water is through the biofilm. Alternatively, a portion of the water can be encouraged to flow through the biofilm, while the remainder of the water can flow past the surface of the biofilm to prevent solids from accumulating on the biofilm surface.

The filter is unlikely to provide the level of treatment that can be provided by an absolute membrane barrier such as a microfilter. Bacterial breakthrough and detachment of solids on the downstream side of the membrane may contribute solids to the water flowing through the membrane. However, there are several potential benefits to this configuration. First, it is likely that the biofilm will dramatically reduce the high concentrations of colloids, particles, and free bacteria that are present in the wastewater. Second, the solids detaching from the downstream side of the biofilm are likely to be present as relatively large and dense flocs that should settle well.

The technology provided herein is applicable to water that contains one or many chemicals that are biodegradable or susceptible to bioconversion. Examples of some of the possible applications include, without limitation, biological oxidation of organic or inorganic compounds, biological reduction of organic or inorganic compounds, and facilitation of biological processes. In some embodiments, for example, the biofilters described herein can be used for biological denitrification, the microbial reduction of nitrate and nitrite to gaseous dinitrogen. Both heterotrophic and autotrophic organisms are capable of denitrification. Autotrophic denitrification may be preferable, however, as autotrophs grow more slowly and produce less biomass than heterotrophs. As a result, autotrophs are likely to have less of an impact on the total organic carbon content of the treated water.

In some embodiments, the biofilters described herein can be used for removal of perchlorate. Perchlorate is a widespread inorganic contaminant in groundwater supplies, especially in western states. It is toxic and can be difficult to remove. However, perchlorate can be reduced by autotrophs when membranes are used to supply hydrogen gas as an electron donor.

The biofilters provided herein include a network of hollow fiber membranes and the interstices bounded by the hollow fibers, together with a biofilm that grows on the surfaces of the fibers and substantially fills the interstices there between. The fibers can be filled with a fluid (e.g., a gas or a liquid) in order to provide the biofilm with particular elements (e.g., oxygen). In some embodiments, the hollow fibers can be filled with an electron acceptor gas such as air or oxygen, and the biofilter can be useful for biological oxidation of organic compounds in processes that include bioremediation and wastewater treatment, for example. In these embodiments, the biofilter also can be used for biological oxidation of inorganic compounds in processes that include nitrification and oxidation of reduced metals, for example. Oxidation reactions facilitated by air or oxygen that are included within these embodiments can include, for example, biological oxidation of hydrocarbons and oils, oxidation of organic compounds to carbon dioxide and water, and nitrification of ammonium to nitrite followed by denitrification of nitrite to nitrate.

In some embodiments, the hollow fibers can be filled with an electron donor gas such as hydrogen, and the biofilter can be used for biological reduction of organic compounds in processes that include bioremediation of perchloroethylene, polychlorinated biphenyls, and perchlorate, for example. Such biofilters also can be used for biological reduction of inorganic compounds in processes that include reduction of oxidized metals and denitrification, for example. Reduction reactions facilitated by hydrogen that are included within these embodiments can include, for example, reduction of sulfate, denitrification of nitrate by reduction to harmless nitrogen gas, reduction of perchlorate to harmless products, and sequential reduction of chlorinated ethenes to harmless ethylene gas.

In some embodiments, the hollow fibers can be filled with a particular nutrient gas (e.g., organic phosphorus) so that the biofilm can facilitate a particular biological process (e.g., processes in which biological activity is restricted by limited nutrient activity).

In some embodiments, different gasses can be passed through the hollow fibers of a single biofilter or of two or more biofilters in series in order to effect the desired reactions. For example, air/oxygen and hydrogen can be added sequentially to two biofilms in series to encourage nitrification of ammonium followed by denitrification with complete N removal. Alternatively, methane and oxygen can support growth of methane oxidizing bacteria, which can co-metabolize chlorinated solvents. In another example, hydrogen and oxygen can be added sequentially to two biofilms in series to encourage reduction of highly chlorinated organics to vinyl chloride, which then can be biodegraded aerobically.

The invention will be further described in the following examples, which do not limit the scope of the invention described in the claims.

### EXAMPLES

### Example 1

### Models for Behavior of Membrane-Aerated Biofilms

Biofilms growing on gas-permeable membranes that are contacted by a flow of wastewater typically receive nutrients and oxygen from opposite sides. That is, oxygen is received from the membranes and nutrients are received from the wastewater on the other side. In this case, both the oxygen and the nutrients enter the film by diffusion. A model is disclosed herein that accounts for the behavior of membrane-aerated biofilms. This model predicts growth and substrate removal behavior from up to four species of bacteria.

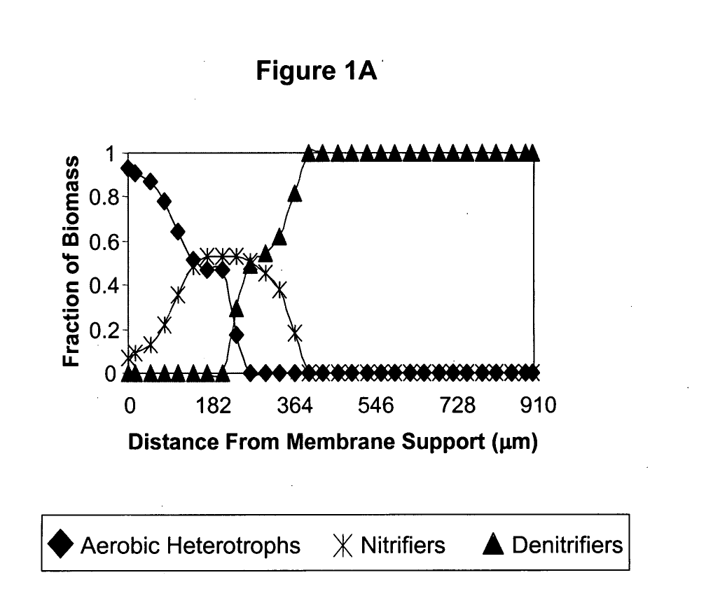

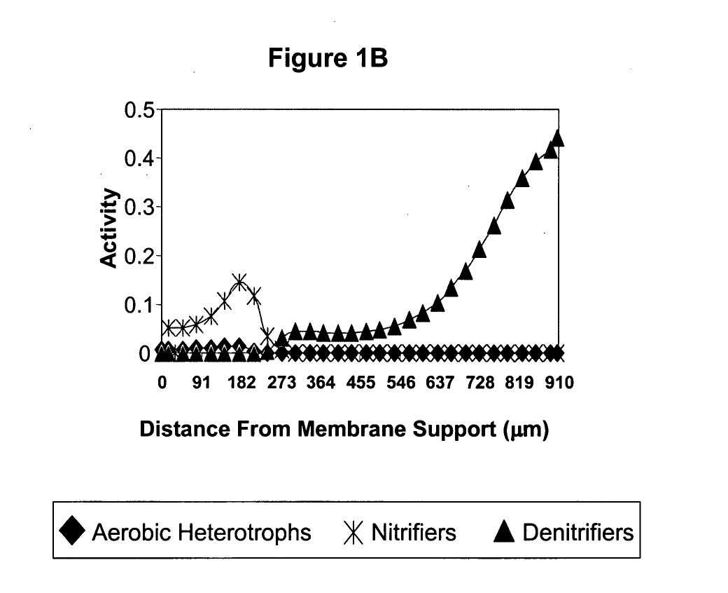

FIGS. 1A and 1B depict the biomass population and activity of microorganisms in a supported biofilm as a function of distance from the aerated membrane support. Aerobic heterotrophs require oxygen and consume organic compounds. Nitrifiers require oxygen and ammonium, and produce nitrite and nitrate. Denitrifiers use nitrate and consume organic compounds. As shown in FIG. 1A, the population of aerobic heterotrophs is greatest near the aerated membrane, while the population of denitrifiers increases as the distance from the membrane increases. The population of nitrifiers peaks between about 150 and about 300 microns from the support.

The activity plotted in FIG. 1B is defined as the activity of the bacteria divided by their maximum activity if conditions for their growth were ideal. This figure illustrates that the activity in membrane-aerated biofilms typically is low. For example, aerobic heterotrophs are thought to operate at about 2% of their effective capacity. This is caused by a thick biofilm that limits the delivery of substrates. Diffusion through the biofilm is slow.

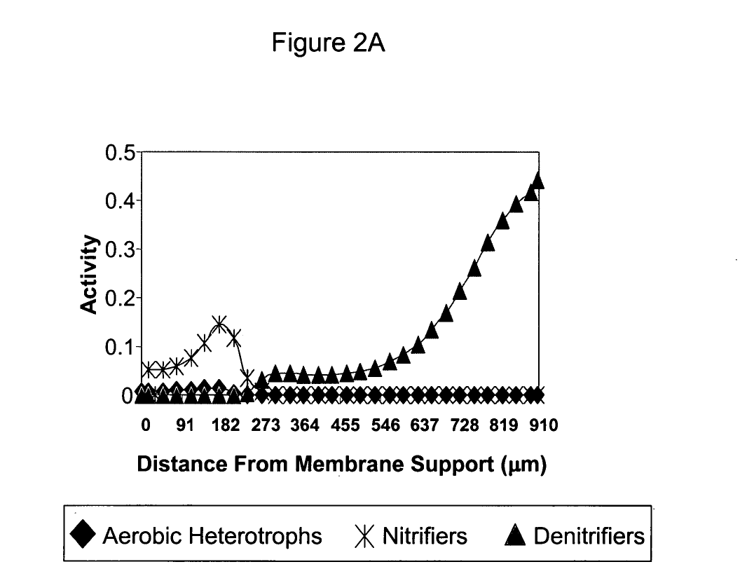

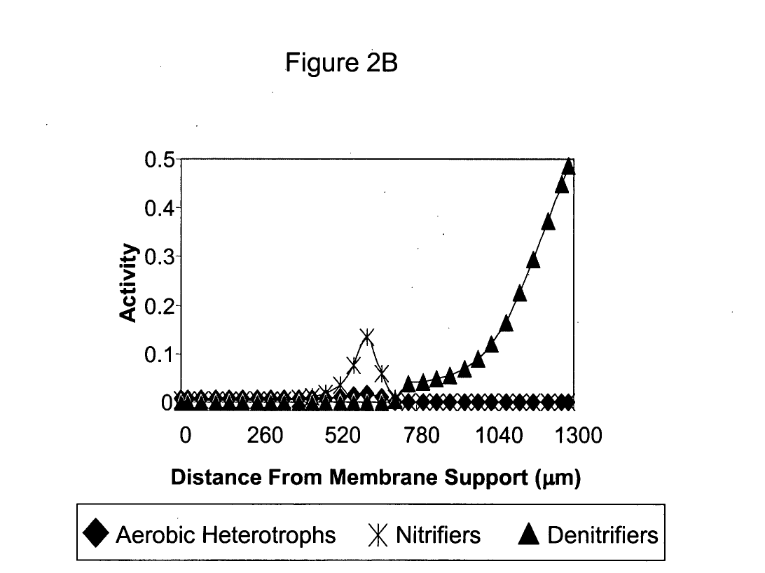

FIGS. 2A and 2B demonstrate that increasing the supply of oxygen by using pure oxygen inside the membranes does not improve the activity. As shown in FIGS. 2A and 2B, a thicker biofilm develops and the activity levels of the bacteria remain low. Most of the nitrifier activity occurs in the middle of the biofilm, while denitrifiers function well close to the outer surface. Aerobic heterotrophs are essentially inactive in this model.

### Example 2

### One Dimensional Model of a Biofilter Subjected to Convective Mass Transport

To increase the mass transport rate through a membrane-aerated biofilm, wastewater can be encouraged to flow through the biofilm to achieve convection in addition to diffusion. FIGS. 3A and 3B depict a model of a biofilter in which a network of parallel, stitched-together hollow fiber membranes is contacted with a biofilm. FIG. 3A depicts a side view along a single membrane. FIG. 3B depicts an end view, looking down the biofilter through several of the stitched-together hollow fiber membranes.

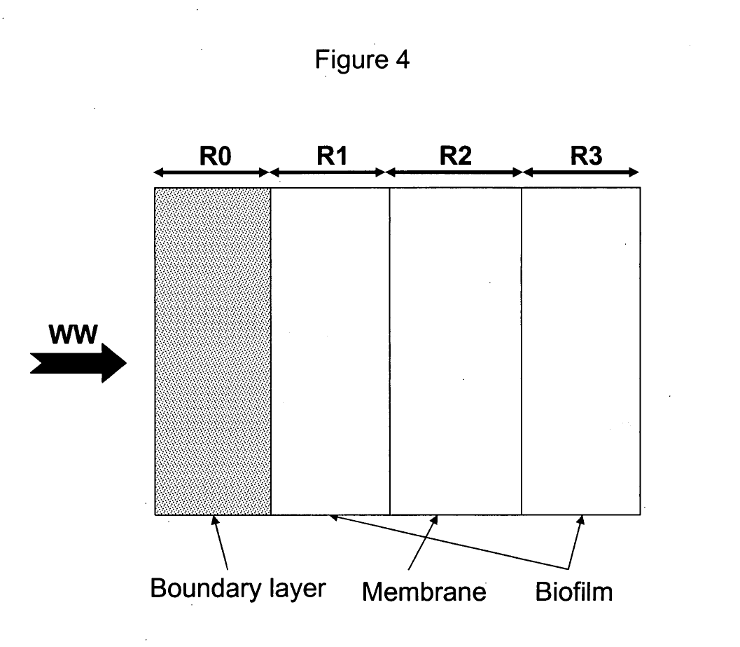

The assumptions for developing this model included the following: influent COD=250 mg/L, steady-state conditions, a one-dimensional domain, a single population of obligate aerobic heterotrophs, no detachment, constant porosity and density, and a constant oxygen concentration (mg/L) in the biofilm between the membrane fibers. Modeling details are shown in FIG. 4, with region 0 (R0) representing the boundary layer, regions 1 and 3 (R1 and R3) representing the biofilm layer, and region 2 (R2) representing the membrane layer (i.e., the biofilm between the membranes). Several equations governing the system were used. Equation (1) was used for substrate (carbon) transport and uptake:

$$u \frac{ⅆ S}{ⅆ x} = Ds \frac{{ⅆ}^{2} S}{ⅆ {x}^{2}} - ks . X . ( \frac{S}{Kx + S} ) . ( \frac{O}{Ko + O} ) \qquad ( 1 )$$

where
Ds=substrate diffusion coefficient (μm²/s)
ks=substrate maximum utilization rate (l/s)
Ks=substrate saturation constant (mg/μm³)
Ko=oxygen saturation constant (mg/μm³)
O=oxygen concentration (mg/μm³)
S=substrate concentration (mg/μm³)
u=fluid velocity (μm/s)
x=distance (μm)
X=biomass density (mg/μm³)
   Equation (1) takes into account the observation that growth can be limited by both oxygen concentration and organic concentration.

Equation (2) was used for oxygen transport and uptake:

$$u \frac{ⅆ O}{ⅆ x} = Do \frac{{ⅆ}^{2} O}{ⅆ {x}^{2}} - ko . X . ( \frac{S}{Ks + S} ) . ( \frac{O}{Ko + O} ) \qquad ( 2 )$$

where
Do=oxygen diffusion coefficient (μm²/s)
ko=oxygen maximum utilization rate (l/s)
Ko=oxygen saturation constant (mg/μm³)
Ks=substrate saturation constant (mg/μm³)
O=oxygen concentration (mg/μm³)
S=substrate concentration (mg/μm³)
u=fluid velocity (μm/s)
x=distance (μm)
X=biomass density (mg/μm³)
   Equation (2) takes into account that oxygen consumption is closely linked to substrate removal by stoichiometry.

Equation (3) was used for growth, and can be used to characterize growth occurring at any point in a biofilm.

$$\int ks . Y . X . ( \frac{S}{Ks + S} ) . ( \frac{O}{Ko + O} ) . ⅆ V = b . X . V \qquad ( 3 )$$

where
b=decay rate (l/s)
dV=volume of each element (μm³)
V=total volume (μm³)
Y=yield coefficient
Ko=oxygen saturation constant (mg/μm³)
Ks=substrate saturation constant (mg/μm³)
O=oxygen concentration (mg/μm³)
S=substrate concentration (mg/μm³)
ko=oxygen maximum utilization rate (l/s)
ks=substrate maximum utilization rate (l/s)

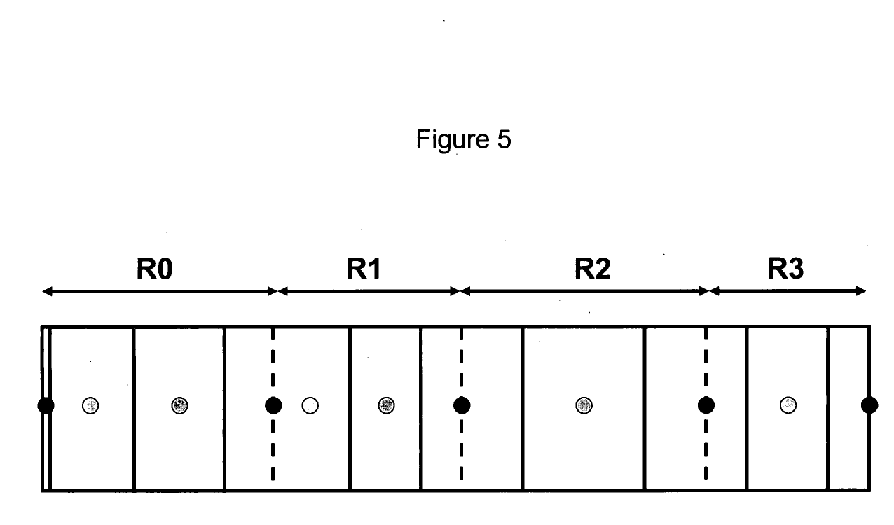

FIG. 5 depicts the distribution of elements and grid nodes used in the model calculations. As in FIG. 4, R0 represents the boundary layer in the liquid, R1 represents the biofilm upstream of the membranes, R2 represents the biofilm between and around the membranes, R3 represents the biofilm downstream of the membranes, and the flow of wastewater occurs from left to right. The circles in FIG. 5 illustrate the basis for the numerical computer solution.

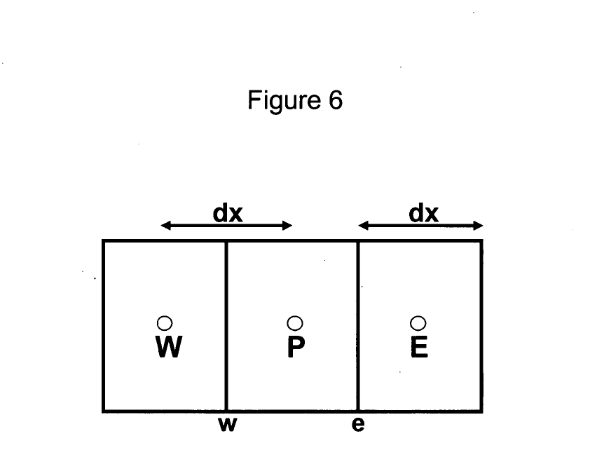

The diagram shown in FIG. 6 was used in a sample calculation across a middle element in R1 of the model biofilm. Equation (4) was used:

$$\frac{[ u . {S}_{w} - Ds . ( {S}_{P} - {S}_{W} ) / dx ]}{IN} - \frac{[ u . {S}_{e} - Ds . ( {S}_{E} - {S}_{P} ) / dx ]}{OUT} - \frac{ks . X . [ 1 / ( S + ks ) ] . [ O / ( O + Ko ) ] . dx}{REMOVAL} = 0 \qquad ( 4 )$$

Other parameters used as initial assumptions in the sample calculations were:
water flux through the biofilm/mesh=25 L/m²-h (velocity about 7 μm/s)
oxygen concentration in the bulk=1 mg/L
oxygen concentration at membrane surface and between membranes=9 mg/L
initial substrate concentration=2560 mg/L (COD)
distance between membrane fibers=300 μm
diameter of membrane fibers=300 μm
flow from left to right
biomass density=30 g/L (typical for biofilms)

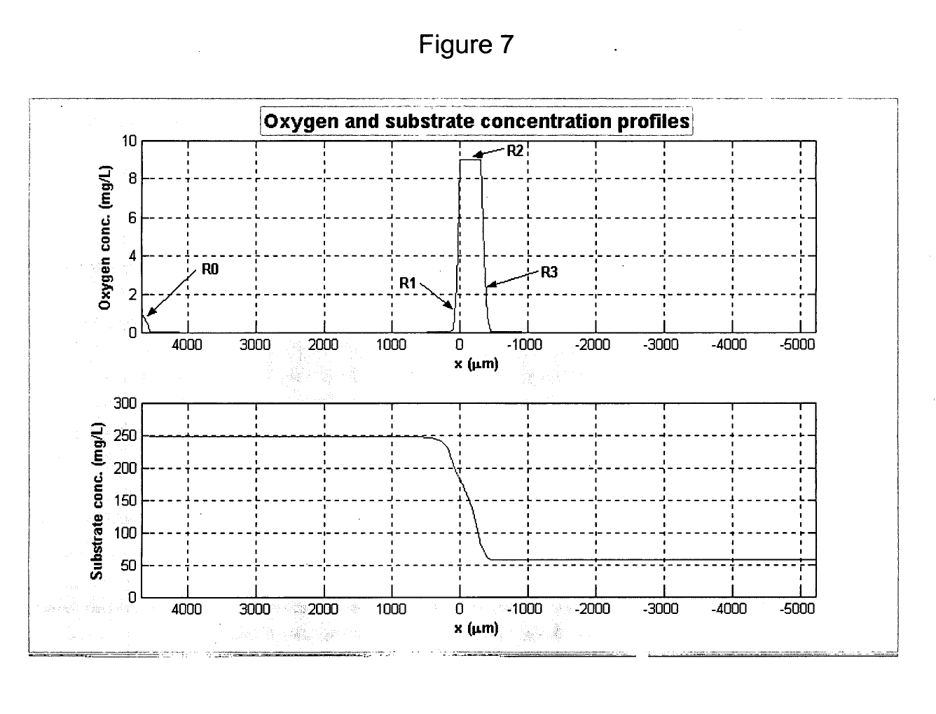

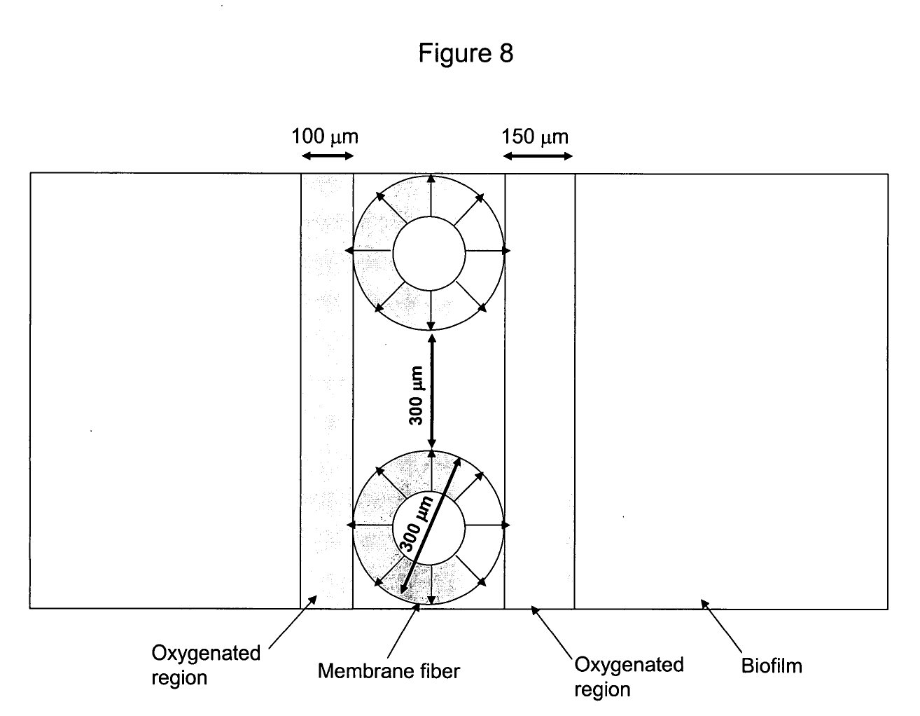

FIG. 7 is a graph of the oxygen and substrate concentration profiles in the model biofilter, showing that essentially all substrate removal occurs in the vicinity of the membranes. As shown in FIG. 8, oxygen tends to diffuse both upgradient and downgradient from the membranes, increasing the effective depth of oxygenated biofilm to about 550 microns. In this model, there is no growth upstream of the membranes because there is only an obligate aerobe population. Thus, the biofilm in region R1 is inactive as depicted in FIG. 7. The same is true for region R3 downstream of the membranes. Between the membranes, over a distance of about 550 microns, the substrate is reduced by about 75%. In this example, the effective contact time with region R2 (the membranes) is less than one minute.

### Example 3

### Two-Dimensional Model of a Biofilter Subjected to Convective Mass Transport

According to the one-dimensional model, the oxygen concentration at the membrane surface and between the membranes was 9 mg/L. It is unlikely, however, that the membranes would maintain that DO concentration in the biofilm between the membranes. Thus, a more accurate model was required to account for oxygen diffusion. As such, a two-dimensional model was used. The assumptions were the same as for the one-dimensional model, except for the following:
two-dimensional diffusion and flow is possible
oxygen was not constant throughout the membrane area; its concentration was determined by diffusion and reaction in the surrounding biofilm
the velocity field was calculated around and between the membranes

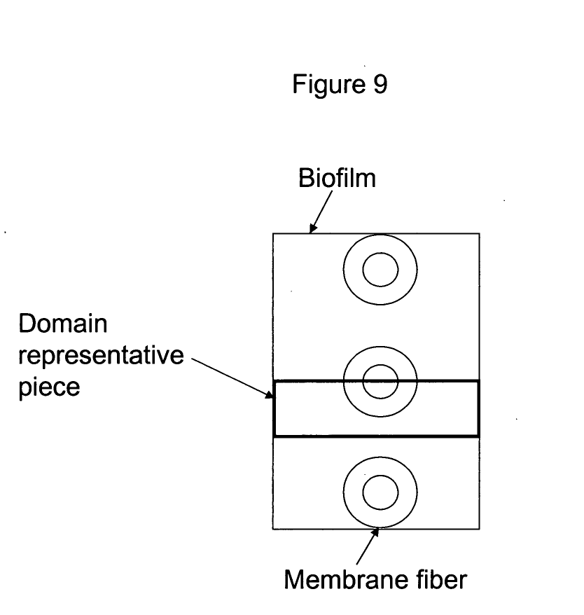

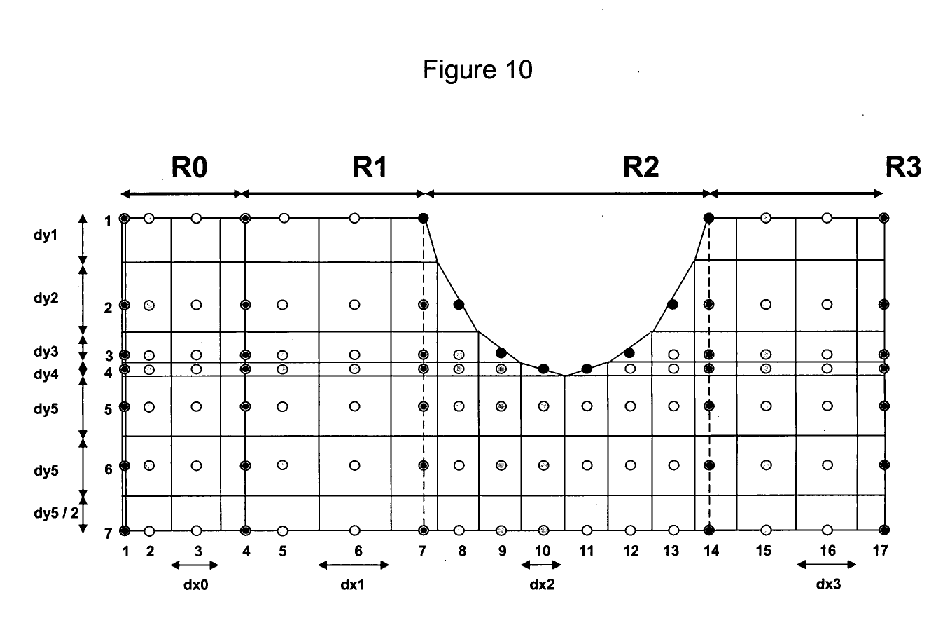

FIG. 9 depicts the domain representative piece used in the calculations for the two-dimensional model, and FIG. 10 shows the distribution of elements and grid nodes used in the model. As above, the saturation oxygen concentration was 9 mg/L at the surface of the membrane.

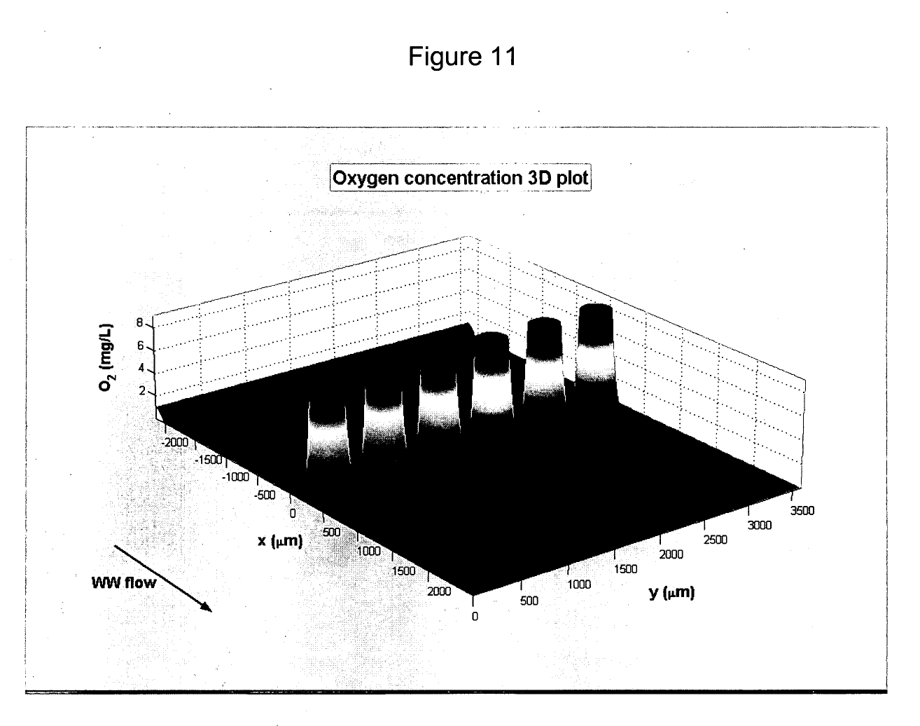

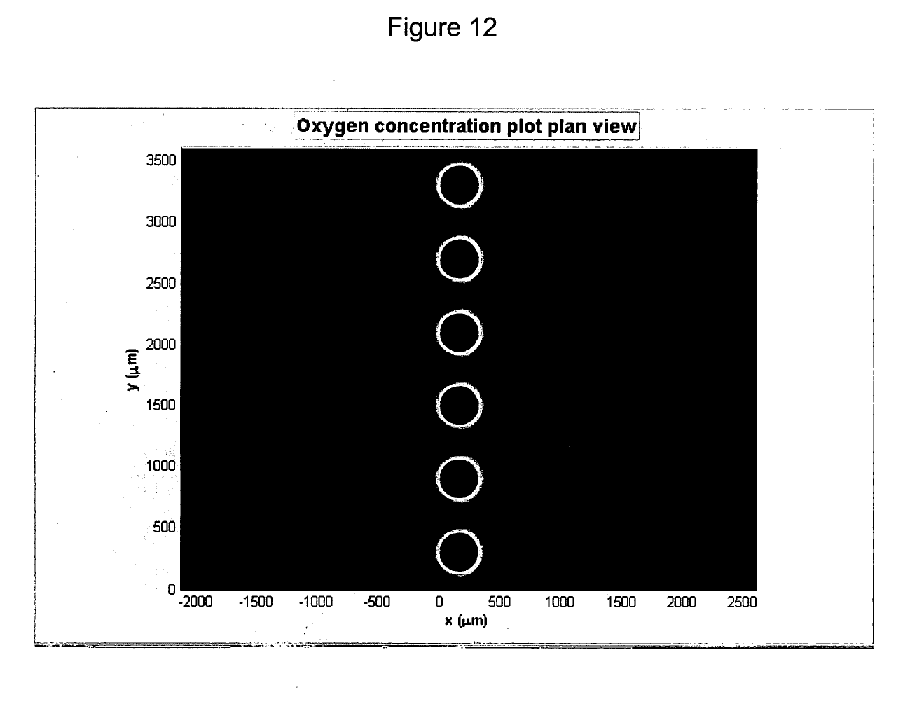

As depicted in FIGS. 11 and 12, the calculations used for the two-dimensional model with air in the membranes revealed that oxygen does not saturate the area between the membranes as assumed in the first analysis. Rather, oxygen saturation was predicted only in the areas surrounding each membrane. The rapid consumption of oxygen around the membranes indicated that under these conditions, the biofilm would not be very effective, and the region of oxygenation should be increased.

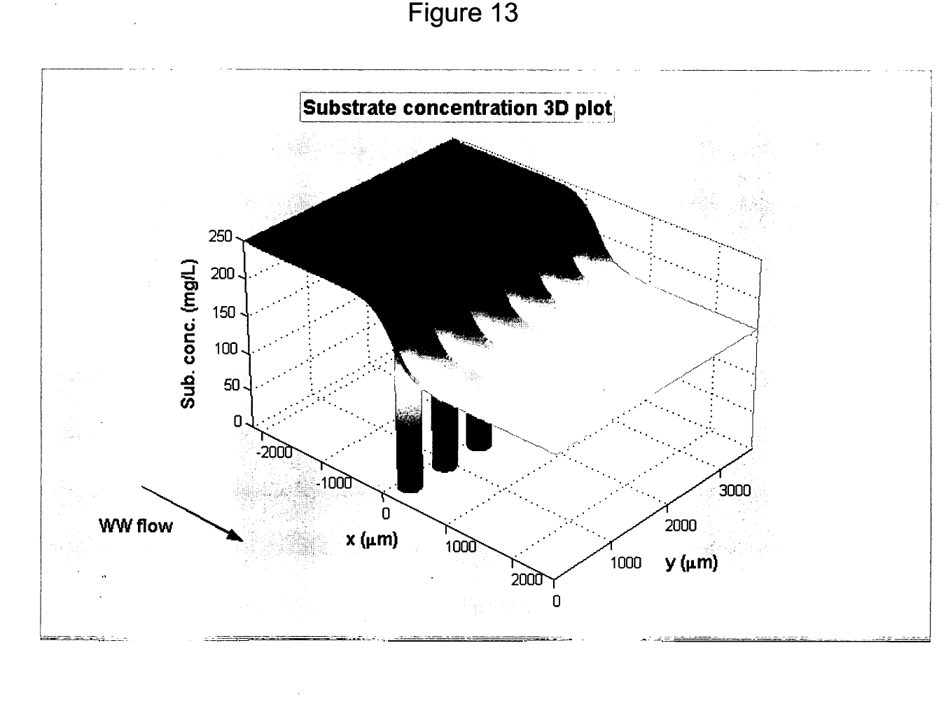

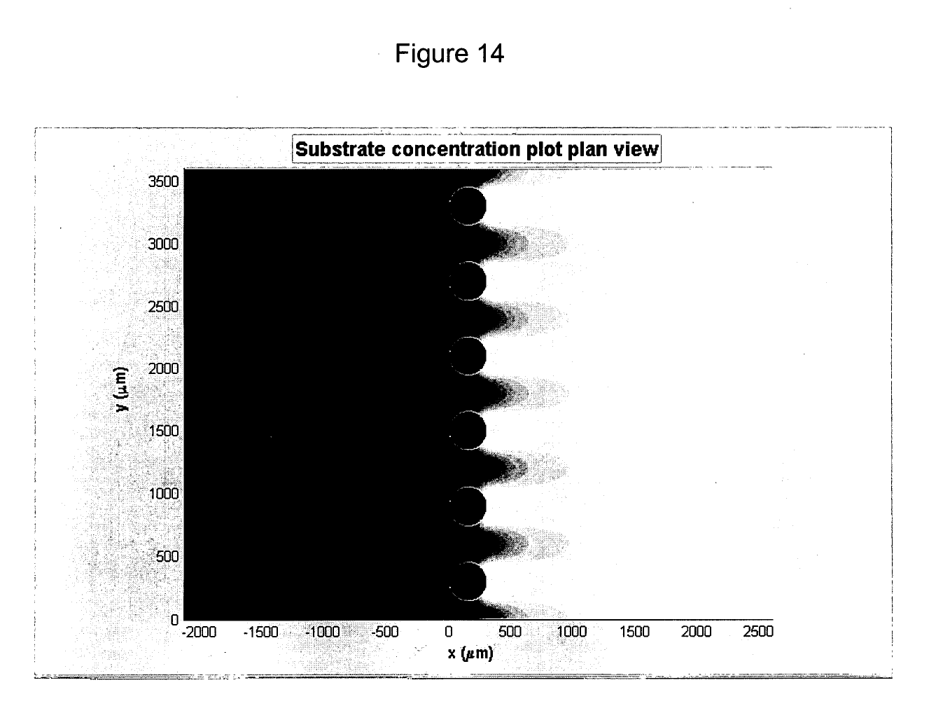

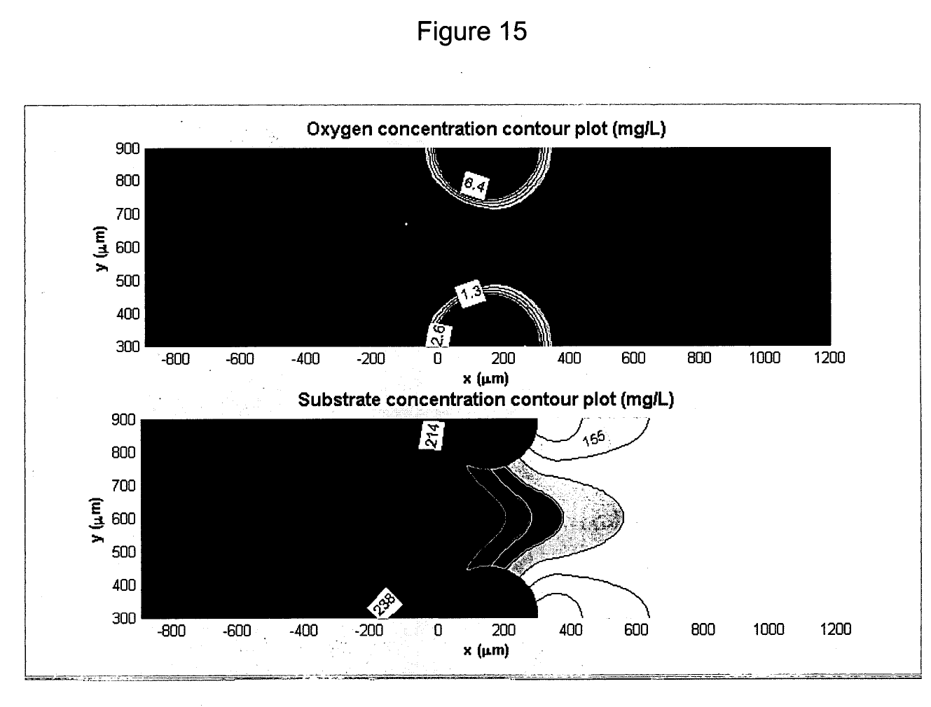

FIGS. 13 and 14 illustrate substrate removal using the same model parameters as those used to generate the graphs shown in FIGS. 11 and 12. Substrate removal was only predicted to be about 25%, as compared to the predicted 75% for the more simplistic one-dimensional model discussed above. This calculation indicated that to improve substrate removal performance, more oxygen would be required. FIG. 15 shows contour plots for oxygen concentration (upper panel) and substrate concentration (lower panel). These graphs depict a close-up of the behavior between two adjacent membranes. The rapid consumption of oxygen (upper panel) leads to the substrate concentration pattern shown in the lower panel.

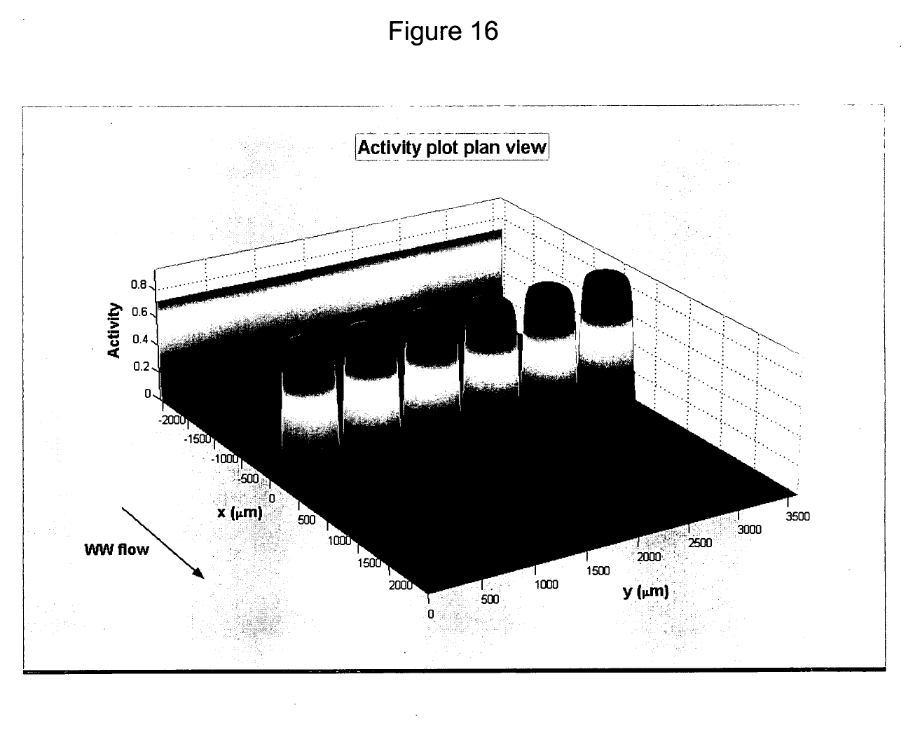

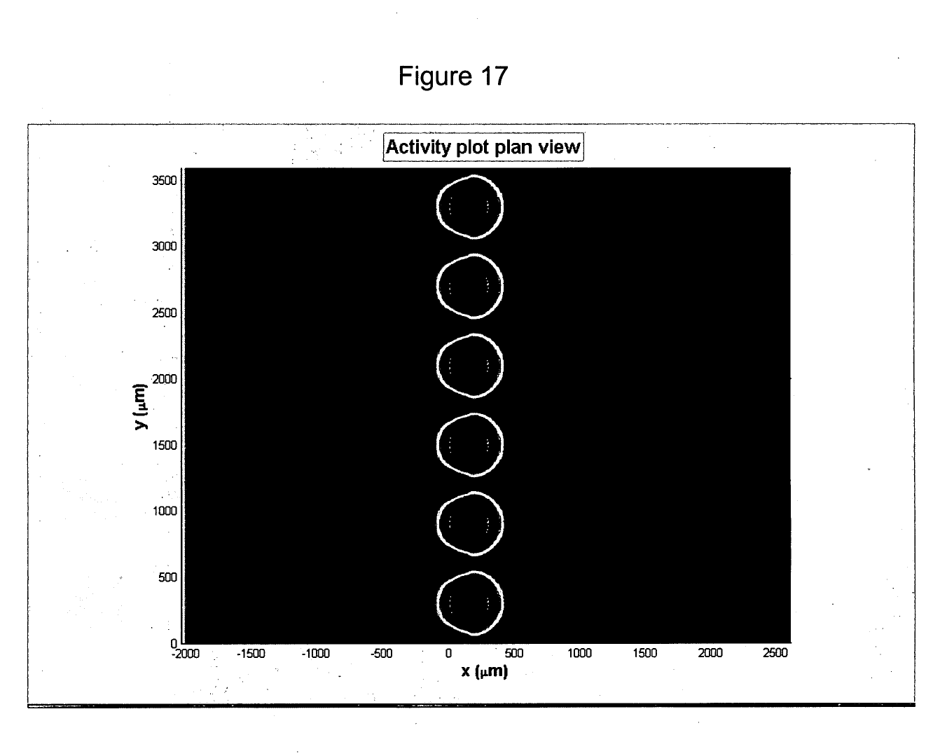

FIGS. 16 and 17 show the activity of microorganisms in the two-dimensional model. Initially, there is some activity in the biofilm since the wastewater contains 1 mg/L of oxygen. This is rapidly depleted, and activity drops to zero. The activity is high around the membranes, but drops to low levels between the membranes because the oxygen concentration is low and the membranes are 300 microns apart.

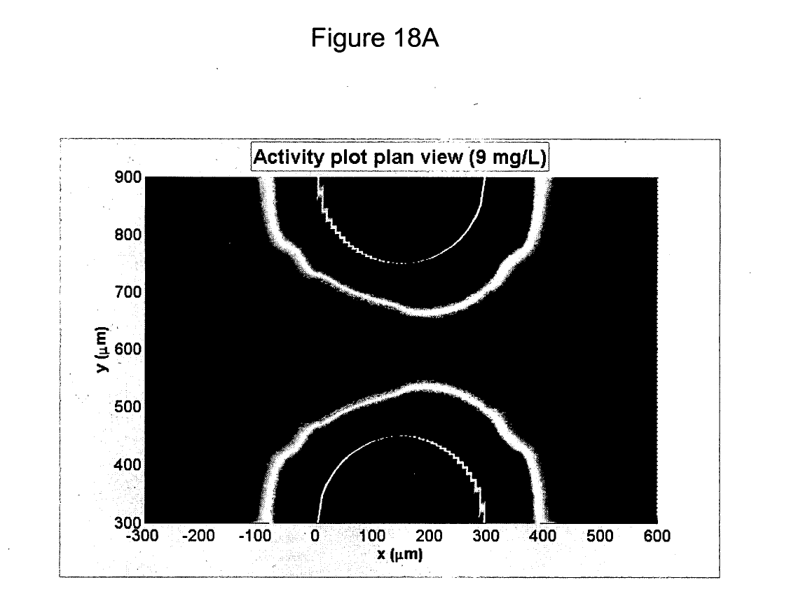

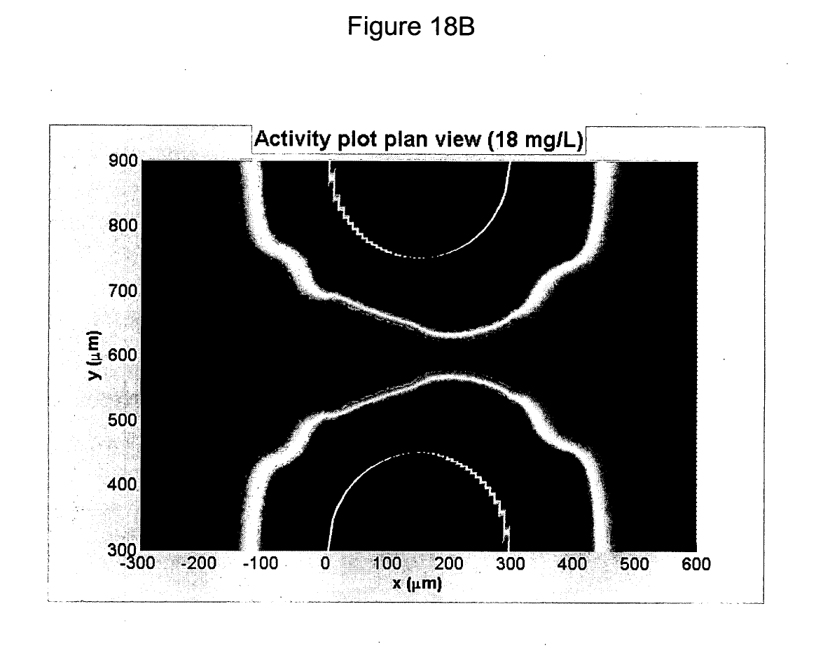

As discussed in Example 1, increasing oxygen in a membrane-aerated biofilm did not have a significant effect on activity and process performance (FIGS. 1A and 1B versus FIGS. 2A and 2B). Rather, the biofilm simply became thicker. In the two-dimensional model with advective flow from left to right, however, increasing the partial pressure of oxygen inside the membranes had a beneficial effect. This is illustrated in FIGS. 18A and 18B, in which the activity at a saturation oxygen concentration of 9 mg/L is compared with the activity at a saturation oxygen concentration of 18 mg/L. The partial pressure was increased from 20% (i.e., air) to about 40% by supplementing air with pure oxygen. (Using pure oxygen would increase the dissolved oxygen concentration to about 45 mg/L.) The increase from 20% to 40% resulted in much more extensive coverage between the membranes, and greater diffusion of oxygen upstream and downstream from the membranes. Thus, manipulating the oxygen pressure in the membranes is an important operating parameter for the biofilters provided herein.

Allowing for the porosity of the biofilm and the space between the membranes in this model, the effective removal was calculated. The areas in which oxygen is present have the following thicknesses: R1, 100 microns; R2, 300 microns; and R3, 110 microns. The fluid velocity within the biofilm was predicted to be 11.7 μm/s in R1 and R3, and 19.2 μm/s in R2. Thus, removal would be achieved in just 34 seconds of contact.

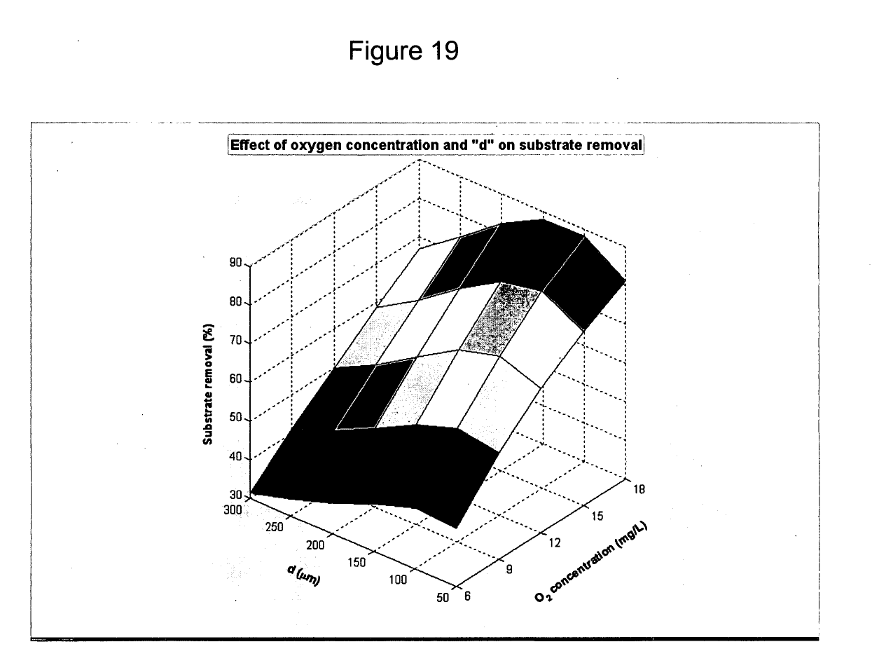

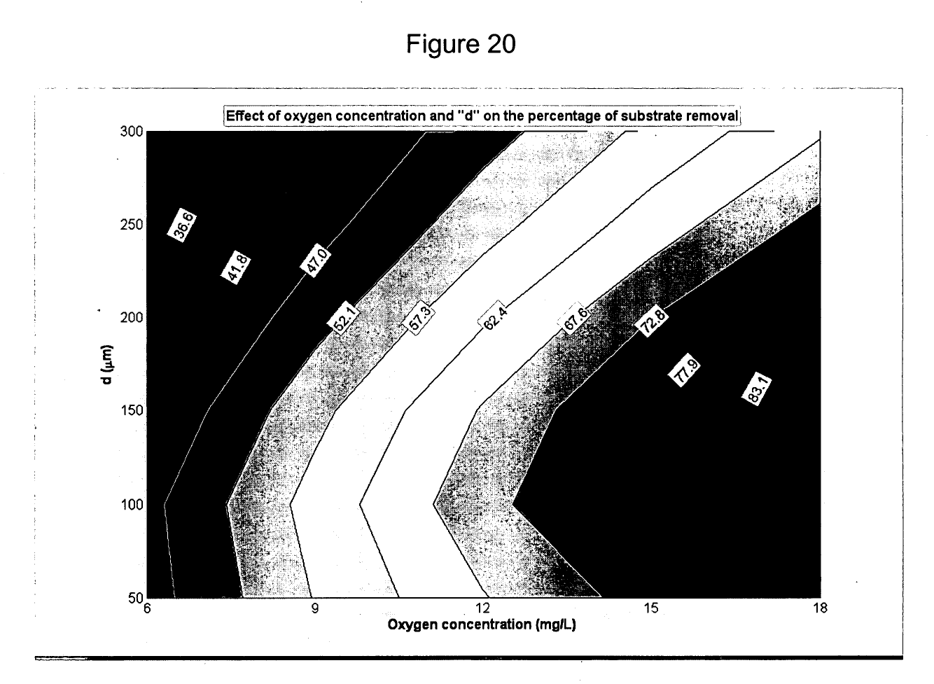

These data suggested that there is a link between membrane spacing, oxygen concentration (i.e., partial pressure of oxygen inside the membranes), and effective removal of substrates. Thus, the two-dimensional model was applied to different membrane spacings and oxygen concentrations. As illustrated in FIGS. 19 and 20, both membrane spacing and oxygen concentration can be manipulated to improve wastewater treatment. In this case, for obligate aerobic heterotrophs only, a membrane spacing of 160 microns and an oxygen concentration of 18 mg/L (e.g., 0.4 atm oxygen in the membranes) yielded 88% removal of the applied 250 mg/L of biodegradable COD. It should be noted that the tighter membrane spacing reduced contact time; the 88% removal was achieved in less than 30 seconds of contact. The oxygen delivery achieved in this case was 2.4 g/m²-h. If pure oxygen were used, the membrane may be even more effective, as it appears that 5 g/m²-h is attainable with this design approach. Moreover, it should be noted that the growth of nitrifiers, denitrifiers, and anaerobes may further improve the performance of the system. A multi-population model can be used to investigate this principle. In addition, the system could be operated with any electron donor or electron acceptor that encourages biofilm growth.

### Example 4

### Experimental Studies Using a Dynamic MAB

Initial experiments were conducted using a membrane module that was fabricated by potting a membrane was potted into stainless steel manifolds for inlet and exhaust air supply. The membrane was then wrapped around a polycarbonate frame with a 3×5 inch central compartment. The membrane was glued to the frame and a permeate suction pump connected to the central compartment drew wastewater through the membrane from both sides. After 112 days of operation, a thick biofilm had formed over the entire membrane. Microscopic examination of the membrane supported biofilm showed that it was replete with protozoans and metazoans. Stalked ciliates, free swimming protozoans, rotifers, and worms were observed and it is likely that they had a significant impact on the structure of the biofilm.

The behavior of this membrane supported biofilm in treating synthetic municipal wastewater. These studies were conducted with a COD of about 250 mg/L and at membrane fluxes of 25 Lmh, with the membranes submerged in conventional aerated bioreactors. It was observed that the turbulent conditions and relatively low COD did not foster the development of a continuous biofilm on the membrane. When the aeration seas turned off and the bioreactor was covered such that the only source of oxygen was the membrane itself, biofilm developed rapidly. Under these conditions, the membrane biofilm performed well when the flux was between 5 and 10 Lmh. The membrane provided about 20% removal of COD (50 mg/L) and significant nitrification. When loaded at 5 Lmh the membrane provided complete nitrification. Permeate nitrate concentrations were low, however, and some COD apparently was removed by denitrification since the biofilm provided up to 75% N removal. The biofilm appeared to be slightly overloaded at 10 Lmh but recovered when it was turned down to 5 Lmh. The pressure drop across the membrane supported biofilm ranged between 1 and 12 inches of water during the course of this study. When the pressure increased (usually at the higher loading rate) it could be reduced by lowering the flux and/or supplying pure oxygen to the membrane. The effluent suspended solids concentration in the permeate averaged 17±7 mg/L once the biofilm became established and no solids were wasted during the 130 day operating period. These early results indicated that significant COD and N removal were achieved across the biofilm and the associated headlosses were minor.

In combination, the computer modeling simulations and preliminary experimental studies suggested the merit of exploring the fundamental behavior of hollow fiber membrane modules designed to operated in cross-flow and support the growth of a continuous active biofilm.

For further studies, a membrane bioreactor was constructed using a polymethylpentene membrane provided by ZENON Environmental Inc. (Oakville, Ontario, Canada). Fibers were aligned in parallel and stitched horizontally with thin non-reactive threads. The fibers had an inner diameter of 26 μm and an outer diameter of 46 μm, and the space between adjacent fibers was about 300-400 μm. On average of about 45 fibers were bundled together; each bundle is referred to herein as a “tow.” There were 11 tows/cm and the tows were stitched together horizontally with non-reactive threads. The space between the tows averaged 420 μm, and the non-reactive threads were spaced about 1 mm horizontally.

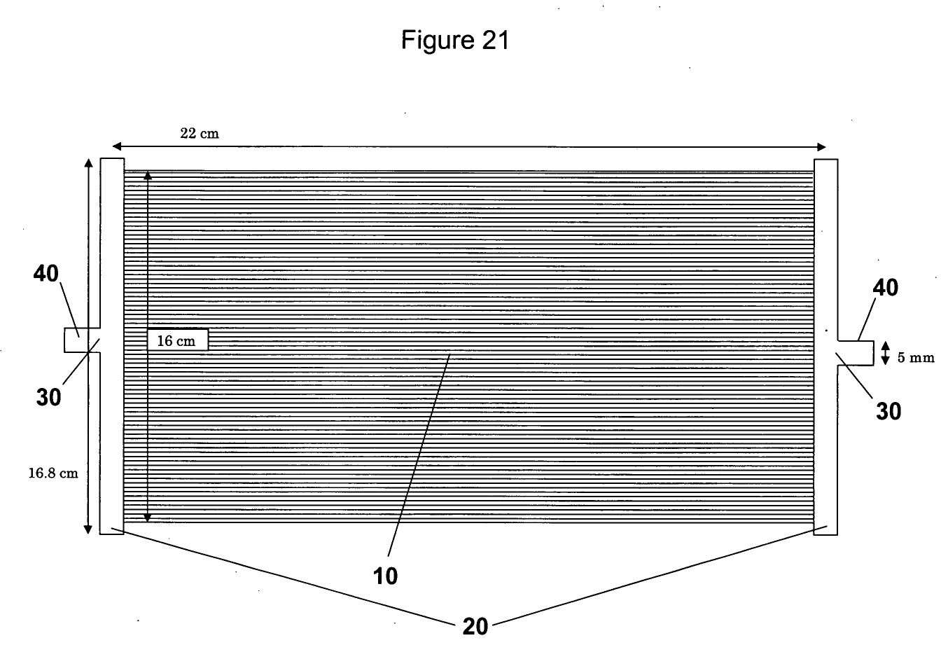

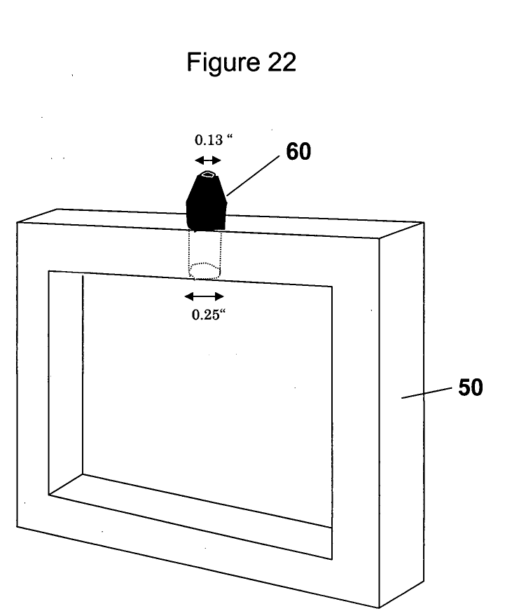

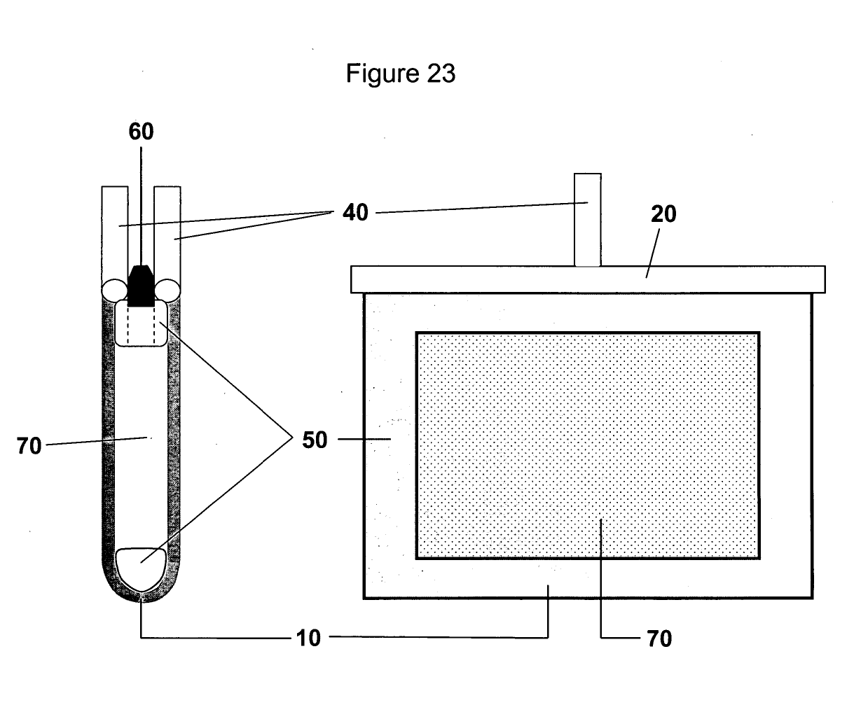

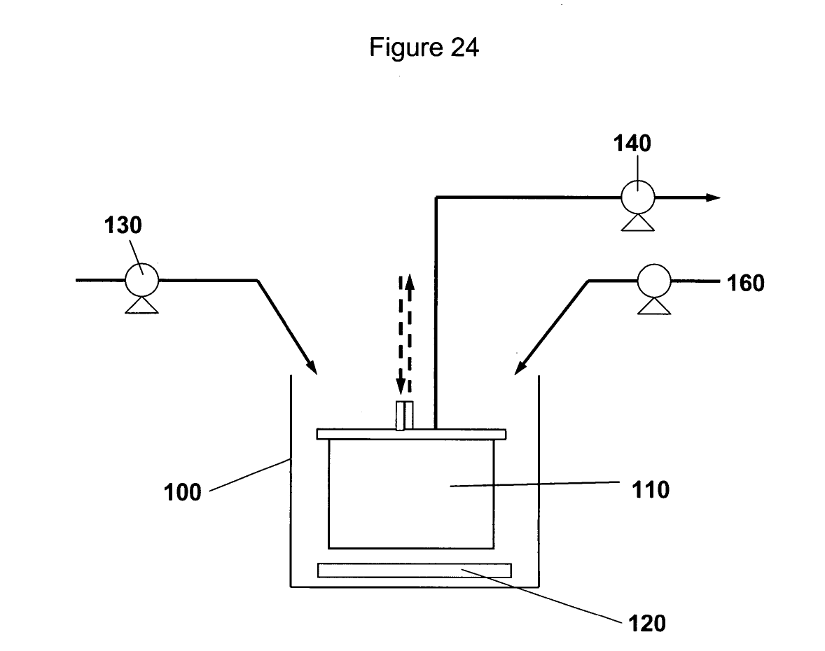

Membrane modules: The following construction method was used to make membrane modules as depicted in FIG. 21. Hollow fiber membrane 10 was cut into pieces 16 cm wide and 22 cm in length. Both ends of the membrane were severed by a razor blade to provide openings for air circulation. Each end of the membrane sheet was attached to stainless steel pipes 20 that were 5 mm in diameter and 16.8 cm in length. A 1/16 inch wide slit was cut along the length of the pipes and Epoxy adhesive—DP 100 (3M Scotch-Weld™) was used to attach the membrane to the pipes. It was necessary to seal the airspaces between the fibers prior to connecting the membrane into the pipes in order to avoid air leakage. Because the spaces between the fibers were so small, the less viscous Epoxy adhesive—DP 125 (3M Scotch-Weld™) was applied near the ends of the membrane repeatedly two to three times to seal the air spaces while not sealing the fibers themselves. Stainless steel pipes 20 had central outlets 30 to which stainless steel pipes 40 of the same diameter were welded to form a “T” (FIG. 22). In this way, pipes 20 and 40 formed gas manifolds for oxygen delivery and exhaust gas venting. For the control membrane, which did not have an air supply, water was inserted through these outlets to exclude air. The membrane with attached gas manifolds at each end was wrapped around transparent plastic frame 50 having effluent outlet 60 as shown in FIG. 23 so that the membrane formed a U-shape (FIG. 24). Frame 60 had a depth of 0.4 inch, outer dimensions of 4 by 6 inches, and defined an opening that was 5 by 3 inches. This opening resulted in effective filtration area 70. Membrane 10 was fixed to plastic frame 50 with Silicon II (GE Sealants & Adhesive) such that water had to flow through the membrane to enter the central compartment.

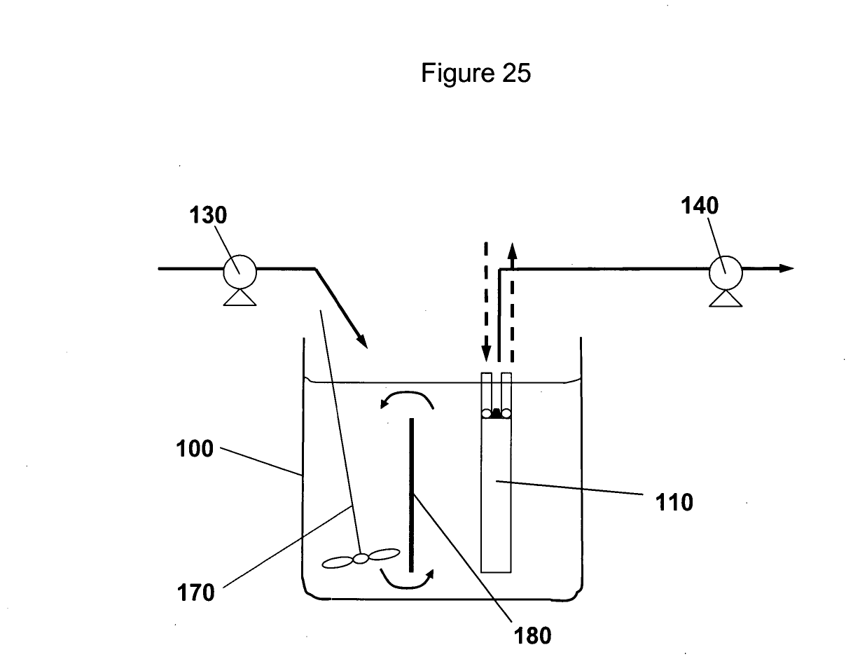

Reactor construction: FIG. 25 shows a schematic graph of the aerobic bioreactor system. Each bioreactor system consisted of tank 100, removable membrane module 110, a mixing system (air diffuser 120), and pumps 130 and 140 for influent and effluent, respectively. Round stainless steel tanks with volumes of 2-4 L were used. During each run, two bioreactor systems were operated in parallel. One contained a membrane module supplied with oxygen through the hollow fibers as indicated by the dashed arrows, while the other contained a water-filled membrane module that functioned as a control. Influent and effluent were pumped by Masterflux drives with an Easy-load II L/S™ head (Cole-Parmer, Chicago, Ill.). Concentrated wastewater was diluted with tap water, which was dechlorinated using a water filter containing activated carbon (Smart Water, GE). The effluent was withdrawn from the top of the membrane module. A manometer was attached to effluent tubing between the membrane module and the effluent pump to measure the headloss across the membrane during filtration. In some cases recycled effluent from Run 1 was pumped back into the bioreactor using pump 160.

Anoxic conditions: For testing under anoxic conditions, air diffuser 120 was replaced by mechanical mixer 170 and baffle 180 was added (FIG. 26). For the anoxic reactors, a variable speed Stir-Pak laboratory mixer (Cole-Parmer, Chicago, Ill.) was installed and its speed was controlled to provide a gentle rolling action in the bioreactor and to ensure that the solids were suspended.

Influent: For the influent, concentrated synthetic wastewater was prepared based on the recipe provided by Nopens et al. (Stability Analysis of a synthetic municipal wastewater, 2001, Technical report, 22 pp.; Water Sci. Technol. 2001, 43(7):387-389). Whole dry milk was used for milk powder. Soy oil was eliminated from the ingredients at an early stage due to clogging problems caused by the viscous nature of soy oil. This concentrated wastewater was sterilized in an autoclave before being connected to the reactors. The concentration of wastewater was fixed, but the concentration of concentrated wastewater and the influent flow rate were adjusted depending on flux. When flux was relatively high, the concentrated wastewater was pumped in for one minute every five minutes while diluting dechlorinated tap water ran continuously. When flux was relatively low, the concentrated feed was pumped in for one minute every ten minutes, while water ran for three minutes starting one minute earlier than the feed and ending one minute after. This five or ten minute cycle was repeated 24 hours a day, seven days a week.

Oxygen supply: Air was supplied to the membrane module using the building air supply attached to a pressure regulator (KENDALL®, Model 10). The air flow rate was 4.7 mL/min. During the experiment, the oxygen supply source was changed from air to pure oxygen. The oxygen flow rate was set to about 12 mL/min and was held constant during each experiment. The exhaust air flow coming out from the end of membrane fibers was checked regularly to ensure the system was operating correctly.

Mixing in reactors: For mixing in the reactors, the mixing rate was set just fast enough to ensure that solids in the bioreactor were suspended. When a one-minute fast mixing was implemented, the mixing rate was elevated so that the reactor was mixed vigorously.

Initial biofilm development: Prior to starting a run, both the aerated and control membrane modules were soaked in mixed liquor for at least 24 hours prior to encourage initial biofilm growth on the membranes. The mixed liquor in the reactor was prepared by adding to the synthetic wastewater a seed sludge sample obtained from the Metropolitan Minneapolis Wastewater Treatment Facility at Pig's Eye Lake, Minn.

Biofilm Observations: Biofilm growth on the support membranes was photographed to record the visual development. At the end of a run, the biofilm structure was photographed in water, and the thickness was estimated using a ruler. Samples from the biofilm and the mixed liquor also were observed through a microscope (Nikon, Eclipse E600, Melville, N.Y.) and photographed (MTI, 3CCD, Michigan City, Ind.).

A dye test was carried out at the end of Run 5 to verify the pathway of wastewater through biofilm. Methylene blue water solution was pumped in reverse direction from top of the membrane module, and the seeping motion of the dye through the biofilm was videotaped and photographed.

Samples typically were collected from the influent and effluent from both membrane aerated bioreactor and control reactor three times a week. Samples from the reactors also were collected to distinguish the contributions of the biofilm to the organic and nutrient removals. Samples for the analysis of pH, total suspended solid concentration, and volatile suspended solids were taken once a week. Dissolved oxygen in the reactors was measured three times a week prior to sampling.

The following tests were run according to standard methods: soluble COD, ammonium nitrogen (NH₃—N), nitrate nitrogen (NO₃⁻N), pH, total suspended solid concentration, and volatile suspended solids. Optical density was measured using a UV-visible electrophotometer (SHIMAZU, TV0160IPC, Kyoto, Japan) at ultraviolet light waive length of 600 nm. Dissolved oxygen in the reactors was measured using a dissolved oxygen meter (HACH Company, sensION8™, Loveland, Colo.), and total carbon was measured using a UV-Persulfate TOC Analyzer (Teledyne Tekmar, Phoenix8000, Mason, Ohio). Filtration pressure was measured either with a U-shaped water-filled manometer or with a pressure gauge (Cecomp Electronics, Inc., DPG1000B, Livertyville, Ill.).

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A biofilter comprising a network of hollow fibers and interstices bounded by said hollow fibers, wherein said hollow fibers comprise gas-permeable walls having exterior and interior surfaces, said interior surfaces defining lumens, wherein said lumens contain a fluid, and wherein a dynamic, continuous biofilm contacts said exterior surfaces and substantially occludes said interstices.

2. The biofilter of claim 1, wherein said network defines a mesh.

3. The biofilter of claim 1, wherein said network defines one or more arrays of parallel or substantially parallel hollow fiber membranes.

4. The biofilter of claim 1, wherein said network is substantially planar.

5. The biofilter of claim 1, wherein said interstices are about 300 microns wide.

6. The biofilter of claim 1, wherein said fluid is a gas.

7. The biofilter of claim 6, wherein said gas is oxygen, air, methane, hydrogen, or carbon dioxide.

8. The biofilter of claim 1, wherein said biofilm comprises microorganisms that oxidize organic and/or inorganic compounds.

9. The biofilter of claim 1, wherein said biofilm comprises microorganisms that reduce organic and/or inorganic compounds.

10. The biofilter of claim 1, wherein said network comprises one or more inlets in fluid communication with said lumens and one or more outlets in fluid communication with said lumens.

11. A biofilter system comprising two or more spaced-apart biofilters of claim 1.

12. A method for treating water, said method comprising contacting the biofilter of claim 1 with flowing water under conditions in which the bulk flow of said water passes through said biofilm.

13. The method of claim 12, wherein said water is wastewater.

14. The method of claim 12, wherein said water is contaminated ground water.

15. A method for treating water, said method comprising contacting the biofilter of claim 1 with flowing water under conditions in which a portion of the water flows through said biofilm, while another portion of the water flows past the surface of said biofilm.

16. The method of claim 15, wherein said water is wastewater.

17. The method of claim 15, wherein said water is contaminated ground water.

18. A method for treating wastewater, said method comprising contacting the biofilter system of claim 11 with flowing wastewater under conditions in which the bulk flow of said wastewater passes sequentially through said two or more spaced-apart biofilters.

19. A method for cultivating a continuous biofilm filter, said method comprising contacting a gas permeable membrane mesh with wastewater and allowing a biofilm to develop, and causing wastewater to flow through said membrane mesh and said biofilm by convective transport.

20. The method of claim 19, wherein the direction of wastewater flow is reversible.

21. The method of claim 19, further comprising delivering a high oxygen flux through said gas permeable membrane mesh to said biofilm.
